(19) United States
(12) Patent Application Publication
(10) Pub. No.: US 2022/0312235 A1
(43) Pub. Date: Sep. 29, 2022

(54) CAUSE-ORIENTED BEAM FAILURE DETERMINATION

(71) Applicant: QUALCOMM Incorporated, San Diego, CA (US)

(72) Inventors: Shanyu ZHOU, San Diego, CA (US); Jelena DAMNJANOVIC, Del Mar, CA (US); Tao LUO, San Diego, CA (US)

(21) Appl. No.: 17/588,005

(22) Filed: Jan. 28, 2022

Related U.S. Application Data
(60) Provisional application No. 63/165,557, filed on Mar. 24, 2021.
(60) Provisional application No. 63/165,506, filed on Mar. 24, 2021.

(51) Int. Cl. H04W 24/08; H04L 5/00; H04B 17/336

(52) U.S. Cl. CPC H04W 24/08; H04L 5/0048; H04B 17/336

(57) ABSTRACT

Various aspects of the present disclosure generally relate to wireless communication. In some aspects, a user equipment (UE) may receive, using a beam, a first reference signal associated with a channel for wireless communication. The UE may receive, using the beam, a second reference signal associated with the channel, wherein a characteristic of the second reference signal comprises an indication for the UE to determine an interference measurement associated with the second reference signal. The UE may generate a cause-oriented beam failure indicator based at least in part on the second reference signal. Numerous other aspects are described.

### CROSS-REFERENCE TO RELATED APPLICATIONS

This patent application claims priority to U.S. Provisional Patent Application No. 63/165,557, filed on Mar. 24, 2021, entitled “CAUSE-ORIENTED BEAM FAILURE INDICATORS,” and to U.S. Provisional Patent Application No. 63/165,506, filed on Mar. 24, 2021, entitled “MULTIPLE REFERENCE SIGNALS FOR CAUSE-ORIENTED BEAM FAILURE DETERMINATION,” each of which is assigned to the assignee hereof. The disclosures of the prior applications are considered part of and are incorporated by reference into this patent application.

### FIELD OF THE DISCLOSURE

Aspects of the present disclosure generally relate to wireless communication and to techniques and apparatuses for multiple reference signals for cause-oriented beam failure determination.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency-division multiple access (FDMA) systems, orthogonal frequency-division multiple access (OFDMA) systems, single-carrier frequency-division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include a number of base stations (BSs) that can support communication for a number of user equipment (UEs). A UE may communicate with a BS via the downlink and uplink. “Downlink” (or “forward link”) refers to the communication link from the BS to the UE, and “uplink” (or “reverse link”) refers to the communication link from the UE to the BS. As will be described in more detail herein, a BS may be referred to as a Node B, a gNB, an access point (AP), a radio head, a transmit receive point (TRP), a New Radio (NR) BS, a 5G Node B, or the like.

The above multiple access technologies have been adopted in various telecommunication standards to provide a common protocol that enables different user equipment to communicate on a municipal, national, regional, and even global level. NR, which may also be referred to as 5G, is a set of enhancements to the LTE mobile standard promulgated by the 3GPP. NR is designed to better support mobile broadband Internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink (DL), using CP-OFDM and/or SC-FDM (e.g., also known as discrete Fourier transform spread OFDM (DFT-s-OFDM)) on the uplink (UL), as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

In some aspects, a method of wireless communication performed by a user equipment (UE) includes receiving, using a beam, a reference signal associated with a channel for wireless communication; and generating a cause-oriented beam failure indicator based at least in part on a determination of a beam failure cause associated with the beam.

In some aspects, a method of wireless communication performed by a UE includes receiving, using a beam, a first reference signal associated with a channel for wireless communication; receiving, using the beam, a second reference signal associated with the channel, wherein a characteristic of the second reference signal comprises an indication for the UE to determine an interference measurement associated with the second reference signal; and generating a cause-oriented beam failure indicator based at least in part on the second reference signal.

In some aspects, a method of wireless communication performed by a network node includes transmitting a cause-oriented beam failure indicator configuration that indicates a cause-oriented beam failure indicator; and transmitting a beam failure determination reference signal associated with a channel for wireless communication.

In some aspects, a method of wireless communication performed by a network node includes transmitting a first reference signal associated with a channel for wireless communication; and transmitting a second reference signal associated with the channel, wherein a characteristic of the second reference signal comprises an indication for a UE to determine an interference measurement associated with the second reference signal and corresponding to a cause-oriented beam failure indicator.

In some aspects, a UE for wireless communication includes a memory; and one or more processors, coupled to the memory, configured to: receive, using a beam, a reference signal associated with a channel for wireless communication; and generate a cause-oriented beam failure indicator based at least in part on a determination of a beam failure cause associated with the beam.

In some aspects, a UE for wireless communication includes a memory; and one or more processors, coupled to the memory, configured to: receive, using a beam, a first reference signal associated with a channel for wireless communication; receive, using the beam, a second reference signal associated with the channel, wherein a characteristic of the second reference signal comprises an indication for the UE to determine an interference measurement associated with the second reference signal; and generate a cause-oriented beam failure indicator based at least in part on the second reference signal.

In some aspects, a network node for wireless communication includes a memory; and one or more processors, coupled to the memory, configured to: transmit a cause-oriented beam failure indicator configuration that indicates a cause-oriented beam failure indicator; and transmit a beam failure determination reference signal associated with a channel for wireless communication.

In some aspects, a network node for wireless communication includes a memory; and one or more processors, coupled to the memory, configured to: transmit a first reference signal associated with a channel for wireless communication; and transmit a second reference signal associated with the channel, wherein a characteristic of the second reference signal comprises an indication for a UE to determine an interference measurement associated with the second reference signal and corresponding to a cause-oriented beam failure indicator.

In some aspects, a non-transitory computer-readable medium storing a set of instructions for wireless communication includes one or more instructions that, when executed by one or more processors of a UE, cause the UE to: receive, using a beam, a reference signal associated with a channel for wireless communication; and generate a cause-oriented beam failure indicator based at least in part on a determination of a beam failure cause associated with the beam.

In some aspects, a non-transitory computer-readable medium storing a set of instructions for wireless communication includes one or more instructions that, when executed by one or more processors of a UE, cause the UE to: receive, using a beam, a first reference signal associated with a channel for wireless communication; receive, using the beam, a second reference signal associated with the channel, wherein a characteristic of the second reference signal comprises an indication for the UE to determine an interference measurement associated with the second reference signal; and generate a cause-oriented beam failure indicator based at least in part on the second reference signal.

In some aspects, a non-transitory computer-readable medium storing a set of instructions for wireless communication includes one or more instructions that, when executed by one or more processors of a network node, cause the network node to: transmit a cause-oriented beam failure indicator configuration that indicates a cause-oriented beam failure indicator; and transmit a beam failure determination reference signal associated with a channel for wireless communication.

In some aspects, a non-transitory computer-readable medium storing a set of instructions for wireless communication includes one or more instructions that, when executed by one or more processors of a network node, cause the network node to: transmit a first reference signal associated with a channel for wireless communication; and transmit a second reference signal associated with the channel, wherein a characteristic of the second reference signal comprises an indication for a UE to determine an interference measurement associated with the second reference signal and corresponding to a cause-oriented beam failure indicator.

In some aspects, an apparatus for wireless communication includes means for receiving, using a beam, a reference signal associated with a channel for wireless communication; and means for generating a cause-oriented beam failure indicator based at least in part on a determination of a beam failure cause associated with the beam.

In some aspects, an apparatus for wireless communication includes means for receiving, using a beam, a first reference signal associated with a channel for wireless communication; means for receiving, using the beam, a second reference signal associated with the channel, wherein a characteristic of the second reference signal comprises an indication for the apparatus to determine an interference measurement associated with the second reference signal; and means for generating a cause-oriented beam failure indicator based at least in part on the second reference signal.

In some aspects, an apparatus for wireless communication includes means for transmitting a cause-oriented beam failure indicator configuration that indicates a cause-oriented beam failure indicator; and means for transmitting a beam failure determination reference signal associated with a channel for wireless communication.

In some aspects, an apparatus for wireless communication includes means for transmitting a first reference signal associated with a channel for wireless communication; and means for transmitting a second reference signal associated with the channel, wherein a characteristic of the second reference signal comprises an indication for a UE to determine an interference measurement associated with the second reference signal and corresponding to a cause-oriented beam failure indicator.

Aspects generally include a method, apparatus, system, computer program product, non-transitory computer-readable medium, user equipment, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, or artificial intelligence-enabled devices). Aspects may be implemented in chip-level components, modular components, non-modular components, non-chip-level components, device-level components, or system-level components. Devices incorporating described aspects and features may include additional components and features for implementation and practice of claimed and described aspects. For example, transmission and reception of wireless signals may include a number of components for analog and digital purposes (e.g., hardware components including antennas, radio frequency (RF) chains, power amplifiers, modulators, buffers, processor(s), interleavers, adders, or summers). It is intended that aspects described herein may be practiced in a wide variety of devices, components, systems, distributed arrangements, or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3 is a diagram illustrating an example of a user plane protocol stack and a control plane protocol stack for a base station and a core network in communication with a UE, in accordance with the present disclosure.

FIG. 4 is a diagram illustrating an example associated with cause-oriented beam failure indicators, in accordance with the present disclosure.

FIG. 5 is a diagram illustrating an example associated with multiple reference signals for cause-oriented beam failure determination, in accordance with the present disclosure.

FIGS. 6-9 are diagrams illustrating example processes associated with cause-oriented beam failure indicators, in accordance with the present disclosure.

FIGS. 10 and 11 are block diagrams of example apparatuses for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein, one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

It should be noted that while aspects may be described herein using terminology commonly associated with a 5G or NR radio access technology (RAT), aspects of the present disclosure can be applied to other RATs, such as a 3G RAT, a 4G RAT, and/or a RAT subsequent to 5G (e.g., 6G).

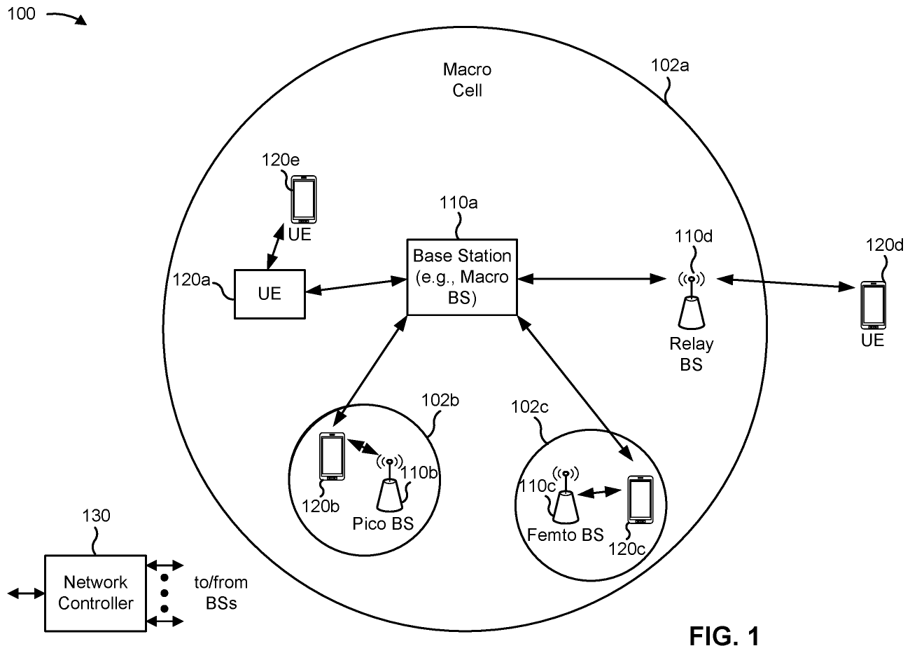

FIG. 1 is a diagram illustrating an example of a wireless network 100, in accordance with the present disclosure. The wireless network 100 may be or may include elements of a 5G (NR) network and/or an LTE network, among other examples. The wireless network 100 may include a number of base stations 110 (shown as BS 110a, BS 110b, BS 110c, and BS 110d) and other network entities. A base station (BS) is an entity that communicates with user equipment (UEs) and may also be referred to as an NR BS, a Node B, a gNB, a 5G node B (NB), an access point, a transmit receive point (TRP), or the like. Each BS may provide communication coverage for a particular geographic area. In 3GPP, the term “cell” can refer to a coverage area of a BS and/or a BS subsystem serving this coverage area, depending on the context in which the term is used.

A BS may provide communication coverage for a macro cell, a pico cell, a femto cell, and/or another type of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a closed subscriber group (CSG)). ABS for a macro cell may be referred to as a macro BS. ABS for a pico cell may be referred to as a pico BS. A BS for a femto cell may be referred to as a femto BS or a home BS. In the example shown in FIG. 1, a BS 110a may be a macro BS for a macro cell 102a, a BS 110b may be a pico BS for a pico cell 102b, and a BS 110c may be a femto BS for a femto cell 102c. A BS may support one or multiple (e.g., three) cells. The terms “eNB”, “base station”, “NR BS”, “gNB”, “TRP”, “AP”, “node B”, “5G NB”, and “cell” may be used interchangeably herein.

In some aspects, a cell may not necessarily be stationary, and the geographic area of the cell may move according to the location of a mobile BS. In some aspects, the BSs may be interconnected to one another and/or to one or more other BSs or network nodes (not shown) in the wireless network 100 through various types of backhaul interfaces, such as a direct physical connection or a virtual network, using any suitable transport network.

Wireless network 100 may also include relay stations. A relay station is an entity that can receive a transmission of data from an upstream station (e.g., a BS or a UE) and send a transmission of the data to a downstream station (e.g., a UE or a BS). A relay station may also be a UE that can relay transmissions for other UEs. In the example shown in FIG. 1, a relay BS 110d may communicate with macro BS 110a and a UE 120d in order to facilitate communication between BS 110a and UE 120d. A relay BS may also be referred to as a relay station, a relay base station, a relay, or the like.

Wireless network 100 may be a heterogeneous network that includes BSs of different types, such as macro BSs, pico BSs, femto BSs, relay BSs, or the like. These different types of BSs may have different transmit power levels, different coverage areas, and different impacts on interference in wireless network 100. For example, macro BSs may have a high transmit power level (e.g., 5 to 40 watts) whereas pico BSs, femto BSs, and relay BSs may have lower transmit power levels (e.g., 0.1 to 2 watts).

A network controller 130 may couple to a set of BSs and may provide coordination and control for these BSs. Network controller 130 may communicate with the BSs via a backhaul. The BSs may also communicate with one another, directly or indirectly, via a wireless or wireline backhaul.

UEs 120 (e.g., 120a, 120b, 120c) may be dispersed throughout wireless network 100, and each UE may be stationary or mobile. A UE may also be referred to as an access terminal, a terminal, a mobile station, a subscriber unit, a station, or the like. A UE may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device or equipment, biometric sensors/devices, wearable devices (smart watches, smart clothing, smart glasses, smart wrist bands, smart jewelry (e.g., smart ring, smart bracelet)), an entertainment device (e.g., a music or video device, or a satellite radio), a vehicular component or sensor, smart meters/sensors, industrial manufacturing equipment, a global positioning system device, or any other suitable device that is configured to communicate via a wireless or wired medium.

Some UEs may be considered machine-type communication (MTC) or evolved or enhanced machine-type communication (eMTC) UEs. MTC and eMTC UEs include, for example, robots, drones, remote devices, sensors, meters, monitors, and/or location tags, that may communicate with a base station, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices, and/or may be implemented as NB-IoT (narrowband internet of things) devices. Some UEs may be considered a Customer Premises Equipment (CPE). UE 120 may be included inside a housing that houses components of UE 120, such as processor components and/or memory components. In some aspects, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks may be deployed in a given geographic area. Each wireless network may support a particular RAT and may operate on one or more frequencies. A RAT may also be referred to as a radio technology, an air interface, or the like. A frequency may also be referred to as a carrier, a frequency channel, or the like. Each frequency may support a single RAT in a given geographic area in order to avoid interference between wireless networks of different RATs. In some cases, NR or 5G RAT networks may be deployed.

In some aspects, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol or a vehicle-to-infrastructure (V2I) protocol), and/or a mesh network. In this case, the UE 120 may perform scheduling operations, resource selection operations, and/or other operations described elsewhere herein as being performed by the base station 110.

Devices of wireless network 100 may communicate using the electromagnetic spectrum, which may be subdivided based on frequency or wavelength into various classes, bands, channels, or the like. For example, devices of wireless network 100 may communicate using an operating band having a first frequency range (FR1), which may span from 410 MHz to 7.125 GHz, and/or may communicate using an operating band having a second frequency range (FR2), which may span from 24.25 GHz to 52.6 GHz. The frequencies between FR1 and FR2 are sometimes referred to as mid-band frequencies. Although a portion of FR1 is greater than 6 GHz, FR1 is often referred to as a “sub-6 GHz” band. Similarly, FR2 is often referred to as a “millimeter wave” band despite being different from the extremely high frequency (EHF) band (30 GHz-300 GHz) which is identified by the International Telecommunications Union (ITU) as a “millimeter wave” band. Thus, unless specifically stated otherwise, it should be understood that the term “sub-6 GHz” or the like, if used herein, may broadly represent frequencies less than 6 GHz, frequencies within FR1, and/or mid-band frequencies (e.g., greater than 7.125 GHz). Similarly, unless specifically stated otherwise, it should be understood that the term “millimeter wave” or the like, if used herein, may broadly represent frequencies within the EHF band, frequencies within FR2, and/or mid-band frequencies (e.g., less than 24.25 GHz). It is contemplated that the frequencies included in FR1 and FR2 may be modified, and techniques described herein are applicable to those modified frequency ranges.

As described herein, a node, which may be referred to as a “node,” a “network node,” or a “wireless node,” may be a base station (e.g., base station 110), a UE (e.g., UE 120), a relay device, a network controller, an apparatus, a device, a computing system, one or more components of any of these, and/or another processing entity configured to perform one or more aspects of the techniques described herein. For example, a network node may be a UE. As another example, a network node may be a base station. A network node may be an aggregated base station and/or one or more components of a disaggregated base station. As an example, a first network node may be configured to communicate with a second network node or a third network node. The adjectives “first,” “second,” “third,” and so on are used for contextual distinction between two or more of the modified noun in connection with a discussion and are not meant to be absolute modifiers that apply only to a certain respective node throughout the entire document. For example, a network node may be referred to as a “first network node” in connection with one discussion and may be referred to as a “second network node” in connection with another discussion, or vice versa. Reference to a UE, base station, apparatus, device, computing system, or the like may include disclosure of the UE, base station, apparatus, device, computing system, or the like being a network node. For example, disclosure that a UE is configured to receive information from a base station also discloses that a first network node is configured to receive information from a second network node. Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad open-ended way. In the example above where a UE being configured to receive information from a base station also discloses a first network node being configured to receive information from a second network node, “first network node” may refer to a first UE, a first base station, a first apparatus, a first device, a first computing system, a first one or more components, a first processing entity, or the like configured to receive the information from the second network; and “second network node” may refer to a second UE, a second base station, a second apparatus, a second device, a second computing system, a second one or more components, a second processing entity, or the like.

As indicated above, FIG. 1 is provided as an example. Other examples may differ from what is described with regard to FIG. 1.

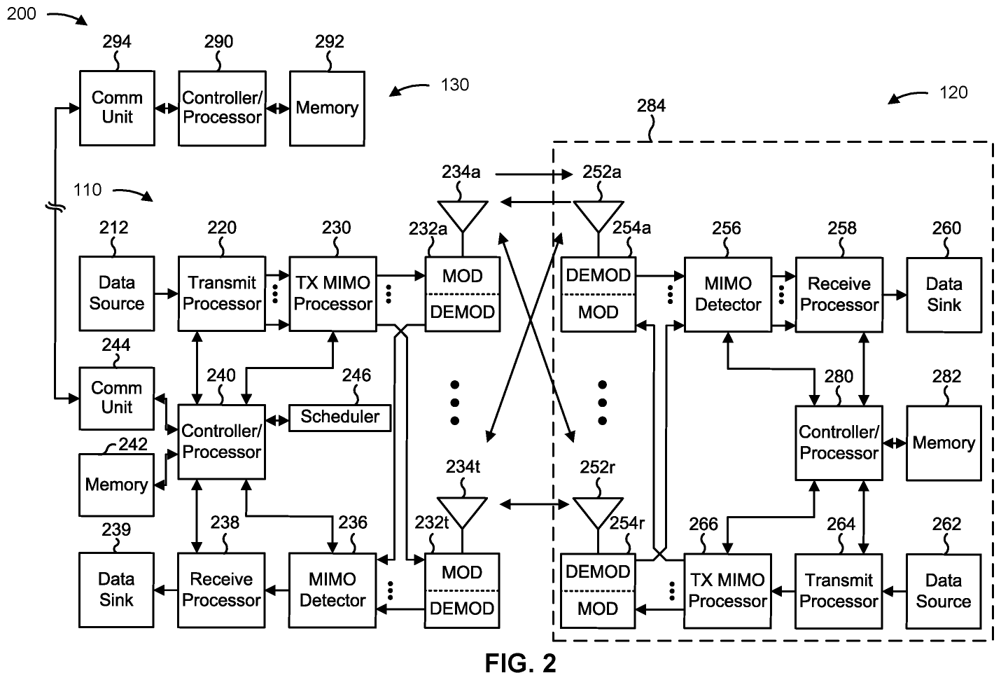

FIG. 2 is a diagram illustrating an example 200 of a base station 110 in communication with a UE 120 in a wireless network 100, in accordance with the present disclosure. Base station 110 may be equipped with T antennas 234a through 234t, and UE 120 may be equipped with R antennas 252a through 252r, where in general T≥1 and R≥1.

At base station 110, a transmit processor 220 may receive data from a data source 212 for one or more UEs, select one or more modulation and coding schemes (MCS) for each UE based at least in part on channel quality indicators (CQIs) received from the UE, process (e.g., encode and modulate) the data for each UE based at least in part on the MCS(s) selected for the UE, and provide data symbols for all UEs. Transmit processor 220 may also process system information (e.g., for semi-static resource partitioning information (SRPI)) and control information (e.g., CQI requests, grants, and/or upper layer signaling) and provide overhead symbols and control symbols. Transmit processor 220 may also generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. Each modulator 232 may process a respective output symbol stream (e.g., for OFDM) to obtain an output sample stream. Each modulator 232 may further process (e.g., convert to analog, amplify, filter, and upconvert) the output sample stream to obtain a downlink signal. T downlink signals from modulators 232a through 232t may be transmitted via T antennas 234a through 234t, respectively.

In some aspects, the term “base station” (e.g., the base station 110) may refer to an aggregated base station, a disaggregated base station, and/or one or more components of a disaggregated base station. For example, in some aspects, “base station” may refer to a control unit, a distributed unit, a plurality of control units, a plurality of distributed units, and/or a combination thereof. In some aspects, “base station” may refer to one device configured to perform one or more functions such as those described above in connection with the base station 110. In some aspects, “base station” may refer to a plurality of devices configured to perform the one or more functions. For example, in some distributed systems, each of a number of different devices (which may be located in the same geographic location or in different geographic locations) may be configured to perform at least a portion of a function, or to duplicate performance of at least a portion of the function, and the term “base station” may refer to any one or more of those different devices. In some aspects, “base station” may refer to one or more virtual base stations, one or more virtual base station functions, and/or a combination of thereof. For example, in some cases, two or more base station functions may be instantiated on a single device. In some aspects, “base station” may refer to one of the base station functions and not another. In this way, a single device may include more than one base station.

At UE 120, antennas 252a through 252r may receive the downlink signals from base station 110 and/or other base stations and may provide received signals to demodulators (DEMODs) 254a through 254r, respectively. Each demodulator 254 may condition (e.g., filter, amplify, downconvert, and digitize) a received signal to obtain input samples. Each demodulator 254 may further process the input samples (e.g., for OFDM) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for UE 120 to a data sink 260, and provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some aspects, one or more components of UE 120 may be included in a housing 284.

Network controller 130 may include communication unit 294, controller/processor 290, and memory 292. Network controller 130 may include, for example, one or more devices in a core network. Network controller 130 may communicate with base station 110 via communication unit 294.

Antennas (e.g., antennas 234a through 234t and/or antennas 252a through 252r) may include, or may be included within, one or more antenna panels, antenna groups, sets of antenna elements, and/or antenna arrays, among other examples. An antenna panel, an antenna group, a set of antenna elements, and/or an antenna array may include one or more antenna elements. An antenna panel, an antenna group, a set of antenna elements, and/or an antenna array may include a set of coplanar antenna elements and/or a set of non-coplanar antenna elements. An antenna panel, an antenna group, a set of antenna elements, and/or an antenna array may include antenna elements within a single housing and/or antenna elements within multiple housings. An antenna panel, an antenna group, a set of antenna elements, and/or an antenna array may include one or more antenna elements coupled to one or more transmission and/or reception components, such as one or more components of FIG. 2.

Each of the antenna elements may include one or more sub-elements for radiating or receiving RF signals. For example, a single antenna element may include a first sub-element cross-polarized with a second sub-element that can be used to independently transmit cross-polarized signals. The antenna elements may include patch antennas, dipole antennas, or other types of antennas arranged in a linear pattern, a two dimensional pattern, or another pattern. A spacing between antenna elements may be such that signals with a desired wavelength transmitted separately by the antenna elements may interact or interfere (e.g., to form a desired beam). For example, given an expected range of wavelengths or frequencies, the spacing may provide a quarter wavelength, half wavelength, or other fraction of a wavelength of spacing between neighboring antenna elements to allow for interaction or interference of signals transmitted by the separate antenna elements within that expected range.

Antenna elements and/or sub-elements may be used to generate beams. “Beam” may refer to a directional transmission such as a wireless signal that is transmitted in a direction of a receiving device. A beam may include a directional signal, a direction associated with a signal, a set of directional resources associated with a signal (e.g., angle of arrival, horizontal direction, vertical direction), and/or a set of parameters that indicate one or more aspects of a directional signal, a direction associated with a signal, and/or a set of directional resources associated with a signal.

As indicated above, antenna elements and/or sub-elements may be used to generate beams. For example, antenna elements may be individually selected or deselected for transmission of a signal (or signals) by controlling an amplitude of one or more corresponding amplifiers. Beamforming includes generation of a beam using multiple signals on different antenna elements, where one or more or all of the multiple signals are shifted in phase relative to each other. The formed beam may carry physical or higher layer reference signals or information. As each signal of the multiple signals is radiated from a respective antenna element, the radiated signals interact, interfere (constructive and destructive interference), and amplify each other to form a resulting beam. The shape (such as the amplitude, width, and/or presence of side lobes) and the direction (such as an angle of the beam relative to a surface of an antenna array) can be dynamically controlled by modifying the phase shifts or phase offsets of the multiple signals relative to each other.

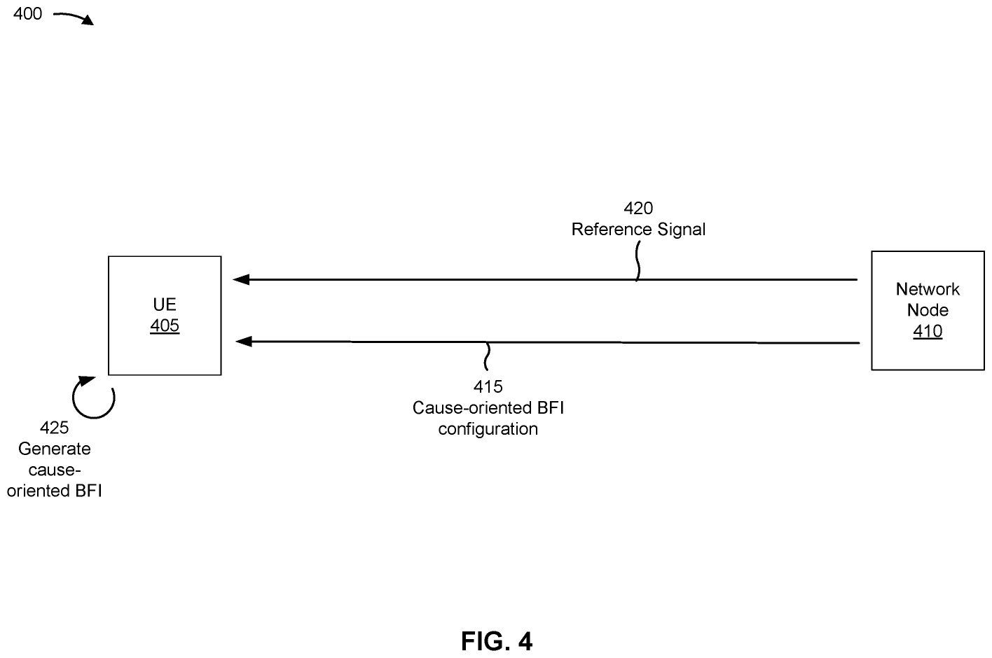

On the uplink, at UE 120, a transmit processor 264 may receive and process data from a data source 262 and control information (e.g., for reports that include RSRP, RSSI, RSRQ, and/or CQI) from controller/processor 280. Transmit processor 264 may also generate reference symbols for one or more reference signals. The symbols from transmit processor 264 may be precoded by a TX MIMO processor 266 if applicable, further processed by modulators 254a through 254r (e.g., for DFT-s-OFDM or CP-OFDM), and transmitted to base station 110. In some aspects, a modulator and a demodulator (e.g., MOD/DEMOD 254) of the UE 120 may be included in a modem of the UE 120. In some aspects, the UE 120 includes a transceiver. The transceiver may include any combination of antenna(s) 252, modulators and/or demodulators 254, MIMO detector 256, receive processor 258, transmit processor 264, and/or TX MIMO processor 266. The transceiver may be used by a processor (e.g., controller/processor 280) and memory 282 to perform aspects of any of the methods described herein (for example, as described with reference to FIGS. 4-11).

At base station 110, the uplink signals from UE 120 and other UEs may be received by antennas 234, processed by demodulators 232, detected by a MIMO detector 236 if applicable, and further processed by a receive processor 238 to obtain decoded data and control information sent by UE 120. Receive processor 238 may provide the decoded data to a data sink 239 and the decoded control information to controller/processor 240. Base station 110 may include communication unit 244 and communicate to network controller 130 via communication unit 244. Base station 110 may include a scheduler 246 to schedule UEs 120 for downlink and/or uplink communications. In some aspects, a modulator and a demodulator (e.g., MOD/DEMOD 232) of the base station 110 may be included in a modem of the base station 110. In some aspects, the base station 110 includes a transceiver. The transceiver may include any combination of antenna(s) 234, modulators and/or demodulators 232, MIMO detector 236, receive processor 238, transmit processor 220, and/or TX MIMO processor 230. The transceiver may be used by a processor (e.g., controller/processor 240) and memory 242 to perform aspects of any of the methods described herein (for example, as described with reference to FIGS. 4-11).

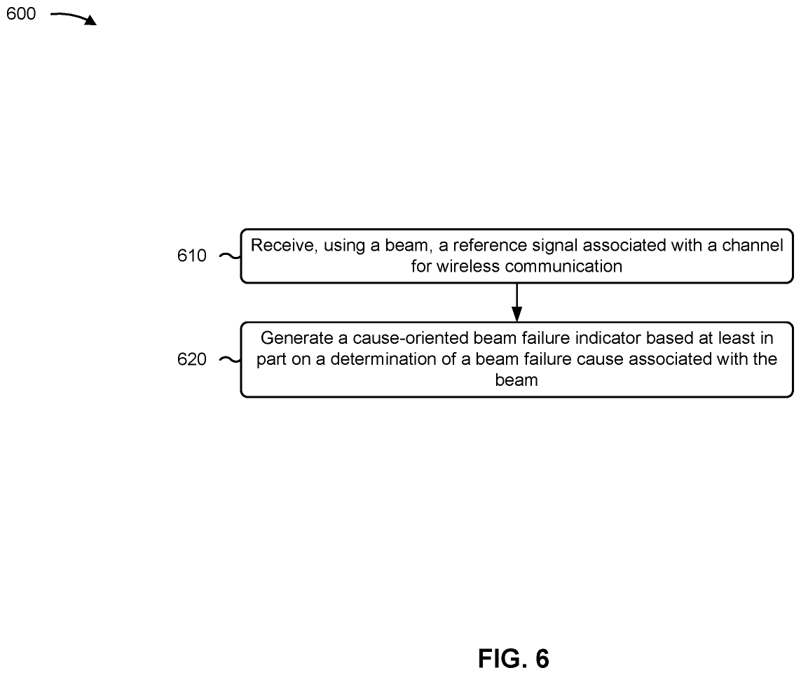

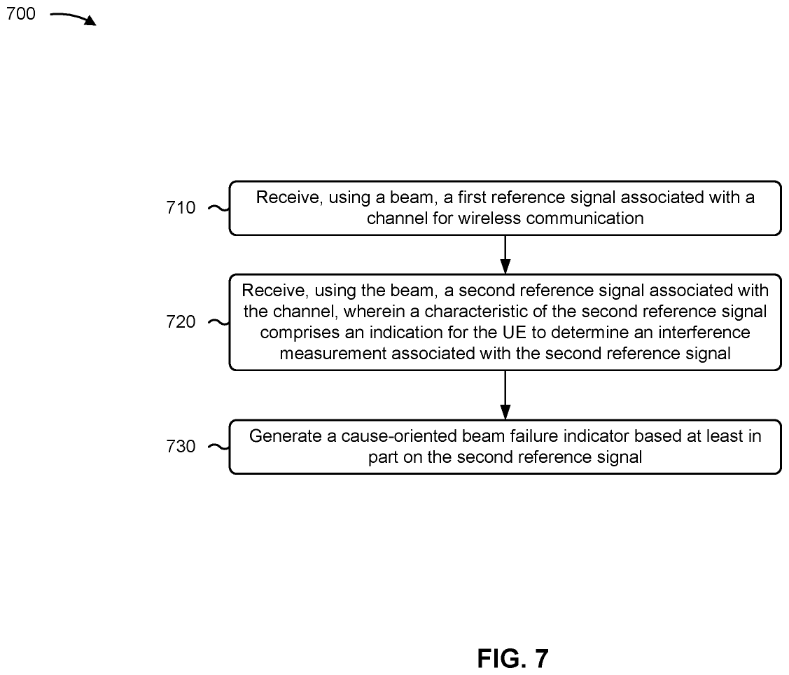

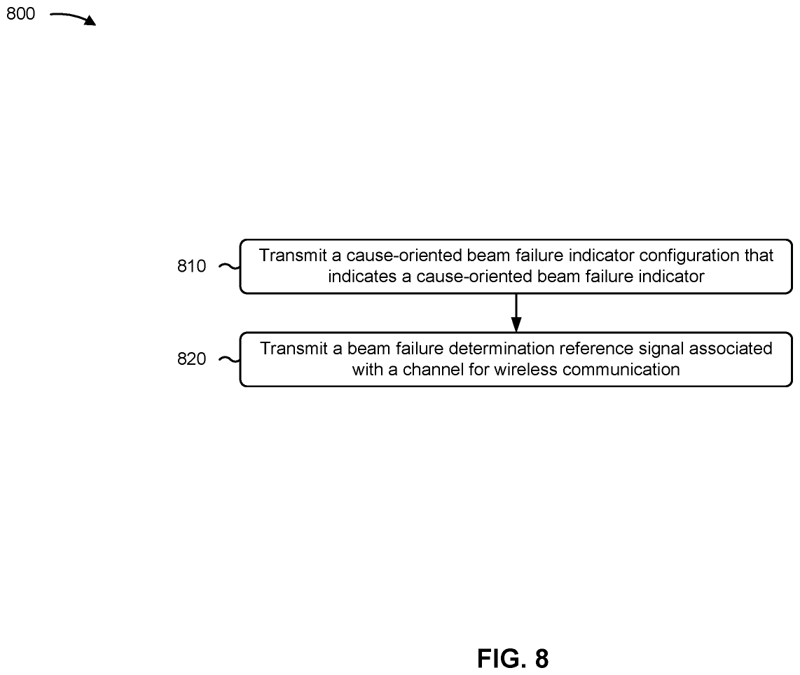

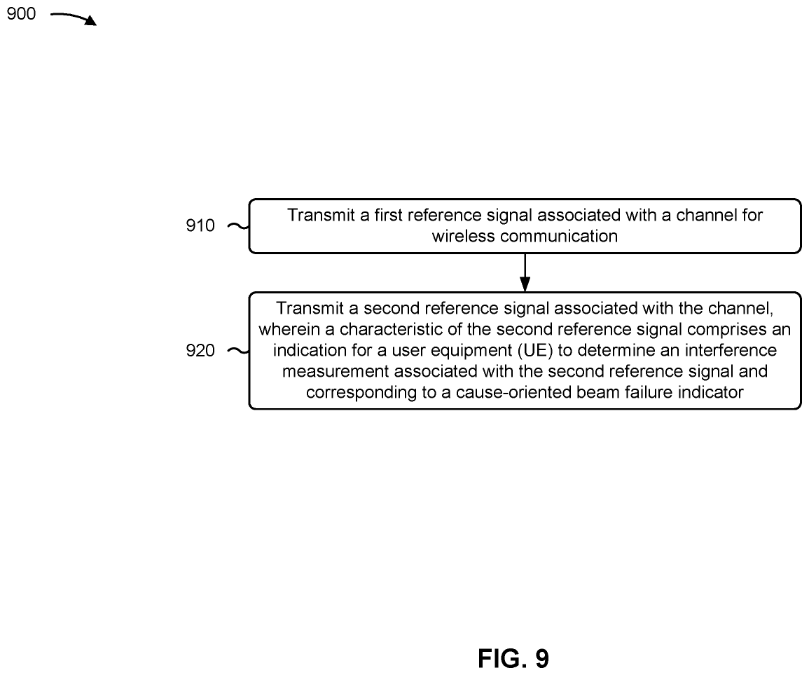

Controller/processor 240 of base station 110, controller/processor 280 of UE 120, and/or any other component(s) of FIG. 2 may perform one or more techniques associated with cause-oriented beam failure determination, as described in more detail elsewhere herein. In some aspects, the network node described herein may be, include, or be included in, a base station, and/or may include one or more components of the base station 110. For example, controller/processor 240 of base station 110, controller/processor 280 of UE 120, and/or any other component(s) of FIG. 2 may perform or direct operations of, for example, process 600 of FIG. 6, process 700 of FIG. 7, process 800 of FIG. 8, process 900 of FIG. 9, and/or other processes as described herein. Memories 242 and 282 may store data and program codes for base station 110 and UE 120, respectively. In some aspects, memory 242 and/or memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 600 of FIG. 6, process 700 of FIG. 7, process 800 of FIG. 8, process 900 of FIG. 9, and/or other processes as described herein. In some aspects, executing instructions may include running the instructions, converting the instructions, compiling the instructions, and/or interpreting the instructions, among other examples.

In some aspects, the UE includes means for receiving, using a beam, a reference signal associated with a channel for wireless communication; or means for generating a cause-oriented BFI based at least in part on a determination of a beam failure cause associated with the beam. In some aspects, a UE includes means for receiving, using a beam, a first reference signal associated with a channel for wireless communication; means for receiving, using the beam, a second reference signal associated with the channel, wherein a characteristic of the second reference signal comprises an indication for the UE to determine an interference measurement associated with the second reference signal; or means for generating a cause-oriented beam failure indicator based at least in part on the second reference signal. The means for the UE to perform operations described herein may include, for example, one or more of antenna 252, demodulator 254, MIMO detector 256, receive processor 258, transmit processor 264, TX MIMO processor 266, modulator 254, controller/processor 280, or memory 282.

In some aspects, the UE includes means for determining the beam failure cause associated with the beam. In some aspects, the UE includes means for determining, based at least in part on the reference signal, a signal-to-interference-plus-noise ratio (SINR) associated with the beam; means for determining that the SINR satisfies a threshold; or means for determining the beam failure cause based at least in part on determining that the SINR satisfies the threshold.

In some aspects, the UE includes means for determining a channel signal strength; means for determining an interference power measurement; or means for determining the beam failure cause based at least in part on the channel signal strength and the interference power measurement. In some aspects, the UE includes means for determining that the channel signal strength satisfies a strength threshold; means for determining that the interference power measurement satisfies an interference threshold; or means for generating the second BFI based at least in part on determining that the channel signal strength satisfies the strength threshold and determining that the interference power measurement satisfies the interference threshold.

In some aspects, the UE includes means for determining that the channel signal strength fails to satisfy a strength threshold; means for determining that the interference power measurement satisfies an interference threshold; or means for generating the first BFI based at least in part on determining that the channel signal strength fails to satisfy the strength threshold and determining that the interference power measurement satisfies the interference threshold.

In some aspects, the UE includes means for determining that the channel signal strength fails to satisfy a strength threshold; means for determining that the interference power measurement fails to satisfy an interference threshold; or means for generating the first BFI based at least in part on determining that the channel signal strength fails to satisfy the strength threshold and determining that the interference power measurement fails to satisfy the interference threshold.

In some aspects, the UE includes means for reporting, using the physical protocol layer, the cause-oriented BFI to a medium access protocol layer of the UE. In some aspects, the UE includes means for determining, using a physical layer protocol of the UE, a channel signal strength; means for determining, using the physical layer protocol of the UE, an interference power measurement; or means for reporting, using the physical layer protocol of the UE, the channel signal strength and the interference power measurement to the MAC layer of the UE.

In some aspects, the UE includes means for receiving a cause-oriented BFI configuration. In some aspects, the UE includes means for receiving a threshold switch indication to switch from a first value of the set of threshold values to a second value of the set of threshold values. In some aspects, the UE includes means for receiving an instruction to determine at least one of a channel signal strength or an interference power measurement, wherein the instruction corresponds to at least one of the one or more reference signal occasions.

In some aspects, the UE includes means for determining the beam failure cause associated with the beam. In some aspects, the UE includes means for determining, based at least in part on the first reference signal, an SINR associated with the beam; means for determining, based at least in part on the second reference signal, an interference measurement and an additional SINR; or means for determining the beam failure cause based at least in part on at least one of the additional SINR or the interference measurement. In some aspects, the UE includes means for receiving a gap configuration that indicates a length of the gap.

In some aspects, the UE includes means for transmitting a request for the second reference signal, wherein receiving the second reference signal comprises receiving the second reference signal based at least in part on transmitting the request for the second reference signal. In some aspects, the UE includes means for detecting an occurrence of a near beam failure trigger condition, wherein transmitting the request for the second reference signal comprises transmitting the request for the second reference signal based at least in part on detecting the occurrence of the near beam failure trigger condition.

In some aspects, the network node includes means for transmitting a cause-oriented BFI configuration that indicates a cause-oriented BFI; or means for transmitting a beam failure determination reference signal associated with a channel for wireless communication. In some aspects, the network node includes means for transmitting a first reference signal associated with a channel for wireless communication; or means for transmitting a second reference signal associated with the channel, wherein a characteristic of the second reference signal comprises an indication for a UE to determine an interference measurement associated with the second reference signal and corresponding to a cause-oriented beam failure indicator. The means for the network node to perform operations described herein may include, for example, one or more of transmit processor 220, TX MIMO processor 230, modulator 232, antenna 234, demodulator 232, MIMO detector 236, receive processor 238, controller/processor 240, memory 242, or scheduler 246.

In some aspects, the network node includes means for transmitting a threshold switch indication to switch from a first value of the set of threshold values to a second value of the set of threshold values. In some aspects, the network node includes means for transmitting an instruction to determine at least one of a channel signal strength or an interference power measurement, wherein the instruction corresponds to at least one of the one or more reference signal occasions.

In some aspects, the network node includes means for transmitting a gap configuration that indicates a length of the gap. In some aspects, the network node includes means for receiving a request for the second reference signal, wherein transmitting the second reference signal comprises transmitting the second reference signal based at least in part on receiving the request for the second reference signal.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of controller/processor 280.

As indicated above, FIG. 2 is provided as an example. Other examples may differ from what is described with regard to FIG. 2.

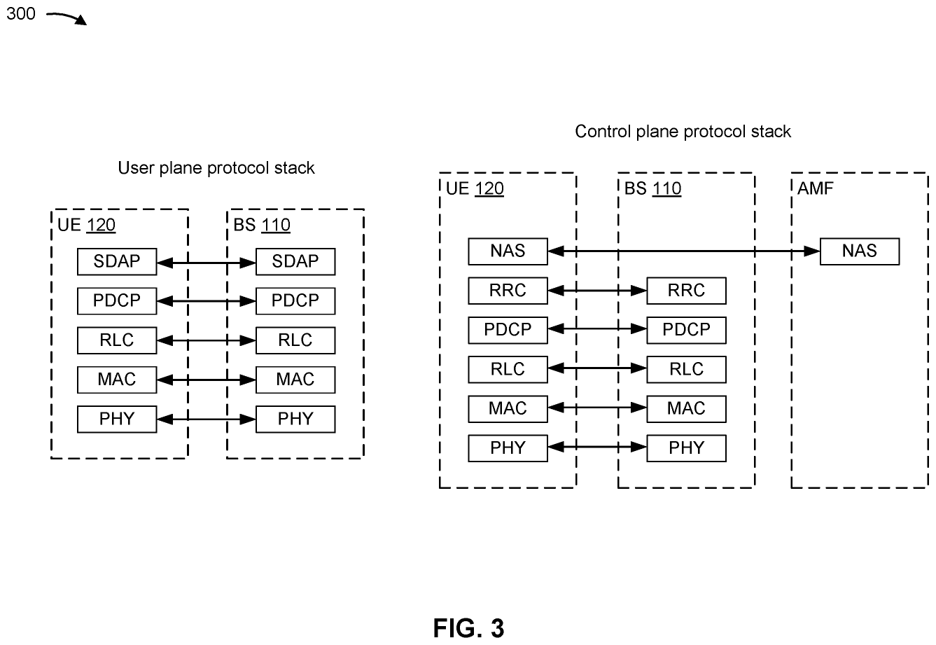

FIG. 3 is a diagram illustrating an example 300 of a user plane protocol stack and a control plane protocol stack for a base station 110 and a core network in communication with a UE 120, in accordance with the present disclosure.

On the user plane, the UE 120 and the BS 110 may include respective physical (PHY) layers, medium access control (MAC) layers, radio link control (RLC) layers, packet data convergence protocol (PDCP) layers, and service data adaptation protocol (SDAP) layers. A user plane function may handle transport of user data between the UE 120 and the BS 110. On the control plane, the UE 120 and the BS 110 may include respective radio resource control (RRC) layers. Furthermore, the UE 120 may include a non-access stratum (NAS) layer in communication with an NAS layer of an access and management mobility function (AMF). The AMF may be associated with a core network associated with the BS 110, such as a 5G core network (5GC) or a next-generation radio access network (NG-RAN). A control plane function may handle transport of control information between the UE and the core network. Generally, a first layer is referred to as higher than a second layer if the first layer is further from the PHY layer than the second layer. For example, the PHY layer may be referred to as a lowest layer, and the SDAP/PDCP/RLC/MAC layer may be referred to as higher than the PHY layer and lower than the RRC layer. An application (APP) layer, not shown in FIG. 3, may be higher than the SDAP/PDCP/RLC/MAC layer. In some cases, an entity may handle the services and functions of a given layer (e.g., a PDCP entity may handle the services and functions of the PDCP layer), though the description herein refers to the layers themselves as handling the services and functions.

The RRC layer may handle communications related to configuring and operating the UE 120, such as: broadcast of system information related to the access stratum (AS) and the NAS; paging initiated by the 5GC or the NG-RAN; establishment, maintenance, and release of an RRC connection between the UE and the NG-RAN, including addition, modification, and release of carrier aggregation, as well as addition, modification, and release of dual connectivity; security functions including key management; establishment, configuration, maintenance, and release of signaling radio bearers (SRBs) and data radio bearers (DRBs); mobility functions (e.g., handover and context transfer, UE cell selection and reselection and control of cell selection and reselection, inter-RAT mobility); quality of service (QoS) management functions; UE measurement reporting and control of the reporting; detection of and recovery from radio link failure; and NAS message transfer between the NAS layer and the lower layers of the UE 120. The RRC layer is frequently referred to as Layer 3 (L3).

The SDAP layer, PDCP layer, RLC layer, and MAC layer may be collectively referred to as Layer 2 (L2). Thus, in some cases, the SDAP, PDCP, RLC, and MAC layers are referred to as sublayers of Layer 2. On the transmitting side (e.g., if the UE 120 is transmitting an uplink communication or the BS 110 is transmitting a downlink communication), the SDAP layer may receive a data flow in the form of a QoS flow. A QoS flow is associated with a QoS identifier, which identifies a QoS parameter associated with the QoS flow, and a QoS flow identifier (QFI), which identifies the QoS flow. Policy and charging parameters are enforced at the QoS flow granularity. A QoS flow can include one or more service data flows (SDFs), so long as each SDF of a QoS flow is associated with the same policy and charging parameters. In some aspects, the RRC/NAS layer may generate control information to be transmitted and may map the control information to one or more radio bearers for provision to the PDCP layer.

The SDAP layer, or the RRC/NAS layer, may map QoS flows or control information to radio bearers. Thus, the SDAP layer may be said to handle QoS flows on the transmitting side. The SDAP layer may provide the QoS flows to the PDCP layer via the corresponding radio bearers. The PDCP layer may map radio bearers to RLC channels. The PDCP layer may handle various services and functions on the user plane, including sequence numbering, header compression and decompression (if robust header compression is enabled), transfer of user data, reordering and duplicate detection (if in-order delivery to layers above the PDCP layer is required), PDCP protocol data unit (PDU) routing (in case of split bearers), retransmission of PDCP service data units (SDUs), ciphering and deciphering, PDCP SDU discard (e.g., in accordance with a timer, as described elsewhere herein), PDCP re-establishment and data recovery for RLC acknowledged mode (AM), and duplication of PDCP PDUs. The PDCP layer may handle similar services and functions on the control plane, including sequence numbering, ciphering, deciphering, integrity protection, transfer of control plane data, duplicate detection, and duplication of PDCP PDUs.

The PDCP layer may provide data, in the form of PDCP PDUs, to the RLC layer via RLC channels. The RLC layer may handle transfer of upper layer PDUs to the MAC and/or PHY layers, sequence numbering independent of PDCP sequence numbering, error correction via automatic repeat requests (ARQ), segmentation and re-segmentation, reassembly of an SDU, RLC SDU discard, and RLC re-establishment.

The RLC layer may provide data, mapped to logical channels, to the MAC layer. The services and functions of the MAC layer include mapping between logical channels and transport channels (used by the PHY layer as described below), multiplexing/demultiplexing of MAC SDUs belonging to one or different logical channels into/from transport blocks (TBs) delivered to/from the physical layer on transport channels, scheduling information reporting, error correction through hybrid ARQ (HARD), priority handling between UEs by means of dynamic scheduling, priority handling between logical channels of one UE by means of logical channel prioritization, and padding.

The MAC layer may package data from logical channels into TBs, and may provide the TBs on one or more transport channels to the PHY layer. The PHY layer may handle various operations relating to transmission of a data signal, as described in more detail in connection with FIG. 2. The PHY layer is frequently referred to as Layer 1 (L1).

On the receiving side (e.g., if the UE 120 is receiving a downlink communication or the BS 110 is receiving an uplink communication), the operations may be similar to those described for the transmitting side, but reversed. For example, the PHY layer may receive TBs and may provide the TBs on one or more transport channels to the MAC layer. The MAC layer may map the transport channels to logical channels and may provide data to the RLC layer via the logical channels. The RLC layer may map the logical channels to RLC channels and may provide data to the PDCP layer via the RLC channels. The PDCP layer may map the RLC channels to radio bearers and may provide data to the SDAP layer or the RRC/NAS layer via the radio bearers.

Data may be passed between the layers in the form of PDUs and SDUs. An SDU is a unit of data that has been passed from a layer or sublayer to a lower layer. For example, the PDCP layer may receive a PDCP SDU. A given layer may then encapsulate the unit of data into a PDU and may pass the PDU to a lower layer. For example, the PDCP layer may encapsulate the PDCP SDU into a PDCP PDU and may pass the PDCP PDU to the RLC layer. The RLC layer may receive the PDCP PDU as an RLC SDU, may encapsulate the RLC SDU into an RLC PDU, and so on. In effect, the PDU carries the SDU as a payload.

In wireless communication, beams may be used between a transmitter of a wireless communication device and a receiver of another wireless communication device to facilitate signal transmission. However, due to the uncertain nature of the wireless environment and potential unexpected blocking, beams may be vulnerable to beam failure. Beam failure may be caused by poor channel quality and/or temporary interference from other beams and/or other radio frequency signals, among other examples.

In some cases a UE may be configured to determine beam failure based on calculating a physical downlink control channel (PDCCH) signal to interference plus noise ratio (SINR). The physical layer of a UE may determine, from the PDCCH SINR, a block error rate (BLER) and compare the SINR and/or the BLER to a threshold. If the SINR and/or BLER satisfies the threshold, the physical layer may provide a beam failure indicator (BFI) to the MAC layer of the UE. However, the BFI only indicates that the SINR and/or BLER satisfies a threshold and does not distinguish between beam failure causes such as poor channel quality and/or interference. Thus, the UE may instantiate beam failure recovery procedures in cases in which the beam failure is due to a temporary interference. In this way, the UE may inefficiently consume processing resources and/or cause unnecessary signaling overhead due to an inability to distinguish beam failure cause and, as a result, may have a negative impact on network performance.

Some aspects of the techniques and apparatuses described herein may provide cause-oriented BFIs. For example, in some aspects, a UE may receive, using a beam, a first reference signal and may determine an SINR associated with the first reference signal. If the SINR satisfies a threshold, the UE may determine a channel signal strength and an interference power measurement. Based at least in part on comparing the channel signal strength and the interference power measurement to respective thresholds, the UE may generate a cause-oriented BFI. The cause-oriented BFI may include a first BFI that indicates that the beam failure is based at least in part on a poor channel quality or a second BFI that indicates that the beam failure is based at least in part on interference. In some aspects, the UE may receive a second reference signal and may determine an interference measurement based at least in part on the second reference signal. Based at least in part on comparing the SINR and the interference measurement to respective thresholds, the UE may generate a cause-oriented BFI. The cause-oriented BFI may include a first BFI that indicates that a potential beam failure is based at least in part on a poor channel quality or a second BFI that indicates that the potential beam failure is based at least in part on interference. In this way, some aspects may facilitate distinguishing beam failure causes, which may enable a UE to initiate beam failure recovery procedures only in appropriate circumstances (e.g., when beam failure is caused by poor signal quality). As a result, some aspects may reduce unnecessary processing and signaling overhead, which may have a positive impact on network performance. Additionally, aspects of the cause-oriented BFI may provide a more precise description of channel conditions, and/or may facilitate power saving and/or delay reduction.

As indicated above, FIG. 3 is provided as an example. Other examples may differ from what is described with regard to FIG. 3.

FIG. 4 is a diagram illustrating an example 400 of cause-oriented beam failure indications, in accordance with the present disclosure. As shown in FIG. 4, a UE 405 and a network node 410 may communicate with one another.

As shown by reference number 415, the network node 410 may transmit, and the UE 405 may receive, a cause-oriented BFI configuration. For example, the network node 410 may transmit a RRC message that includes the cause-oriented BFI configuration. In some aspects, the RRC message may indicate a set of threshold values associated with at least one of a strength threshold or an interference threshold. In some aspects, the cause-oriented BFI configuration may indicate a first BFI that is configured to indicate a failure of the beam based at least in part on a channel quality of the channel, a second BFI that is configured to indicate a failure of the beam based at least in part on interference, a strength threshold, and/or an interference threshold, among other examples.

In some aspects, the network node 410 may transmit, and the UE 405 may receive, a threshold switch indication to switch from a first value of the set of threshold values to a second value of the set of threshold values. For example, the network node 410 may transmit the threshold switch indication using a downlink control information (DCI) transmission and/or a MAC control element (MAC CE).

As shown by reference number 420, the network node 410 may transmit, and the UE 405 may receive, using a beam, a reference signal. The reference signal may include a beam failure determination reference signal (BFD-RS) associated with a channel for wireless communication. In some aspects, the reference signal may include a dedicated BFD-RS. The reference signal may correspond to one or more reference signal occasions and the network node 410 may transmit, and the UE 405 may receive, an instruction to determine at least one of a channel signal strength or an interference power measurement. The instruction may correspond to at least one of the one or more reference signal occasions. For example, the instruction may be transmitted with the reference signal in one or more of the reference signal occasions.

As shown by reference number 425, the UE 405 may generate a cause-oriented BFI based at least in part on a determination of a beam failure cause associated with the beam. In some aspects, the UE 405 may determine the beam failure cause. In some aspects, the UE 405 may perform a preliminary determination associated with an SINR associated with the beam. For example, the UE 405 may determine, based at least in part on the reference signal, an SINR associated with the beam, and may determine whether the SINR satisfies a threshold. If the SINR does not satisfy the threshold, the UE 405 may terminate the beam failure determination process. If the SINR satisfies the threshold, the UE 405 may determine the beam failure cause.

In some aspects, the UE 405 may determine the beam failure cause based at least in part determining a channel signal strength and determining an interference power measurement. The UE 405 may compare the channel signal strength to a strength threshold. The UE 405 also may compare the interference power measurement to an interference threshold. Based at least in part on the comparisons, the UE 405 may generate a cause-oriented BFI and provide that BFI to one or more upper layers of the UE 405. In response to generation of the cause-oriented BFI, the UE 405 may initiate a beam failure recovery procedure, for example. The cause-oriented BFI may include a first BFI (which may be represented as “BFI_noise”) that indicates a failure of the beam based at least in part on a channel quality of the channel. The cause-oriented BFI may include a second BFI (which may be represented as “BFI_interference”) that indicates a failure of the beam based at least in part on interference. In some aspects, one or more aspects of the beam failure recovery procedure may be based at least in part on the type of BFI generated. For example, a first type of beam failure recovery procedure may be used based at least in part on generating a BFI_noise and a second type of beam failure recovery procedure may be used based at least in part on generating a BFI_interference.

In some aspects, the UE 405 may generate the first BFI or the second BFI based at least in part on the relationship indicated in the table below, Table 1. In Table 1, “High Interference” indicates that the interference power measurement satisfies an interference threshold, “Low Interference” indicates that the interference power measurement fails to satisfy the interference threshold, “High Channel Strength” indicates that the signal strength satisfies a strength threshold, and “Low Channel Strength” indicates that the signal strength fails to satisfy the strength threshold.

TABLE 1

| | High Interference | Low Interference |
|---|---|---|
| High Channel Strength | BFI_interference | No BFI |
| Low Channel Strength | BFI_noise | BFI_noise |

As shown in Table 1 above, the UE 405 may determine that the channel signal strength satisfies a strength threshold and that the interference power measurement satisfies an interference threshold. Based at least in part on these determinations, the UE 405 may generate the second BFI (BFI_interference). The UE 405 may determine that the channel signal strength fails to satisfy a strength threshold and that the interference power measurement satisfies an interference threshold. Based at least in part on these determinations, the UE 405 may generate the first BFI (BFI_noise). The UE 405 may determine that the channel signal strength fails to satisfy a strength threshold and that the interference power measurement fails to satisfy an interference threshold. Based at least in part on these determinations, the UE 405 may generate the first BFI (BFI_noise). In some aspects, the UE 405 may determine that the channel signal strength satisfies the signal strength threshold and that the interference power measurement fails to satisfy the interference threshold. Based at least in part on these determinations, the UE 405 may generate no BFI.

In some aspects, a physical protocol layer of the UE 405 may generate the cause-oriented BFI. The physical protocol layer may report the cause-oriented BFI to a MAC layer of the UE 405. In some aspects, the MAC layer of the UE 405 may generate the cause-oriented BFI. For example, the physical layer may determine the channel signal strength and the interference power measurement and may report the channel signal strength and the interference power measurement to the MAC layer.

As indicated above, FIG. 4 is provided as an example. Other examples may differ from what is described with respect to FIG. 4.

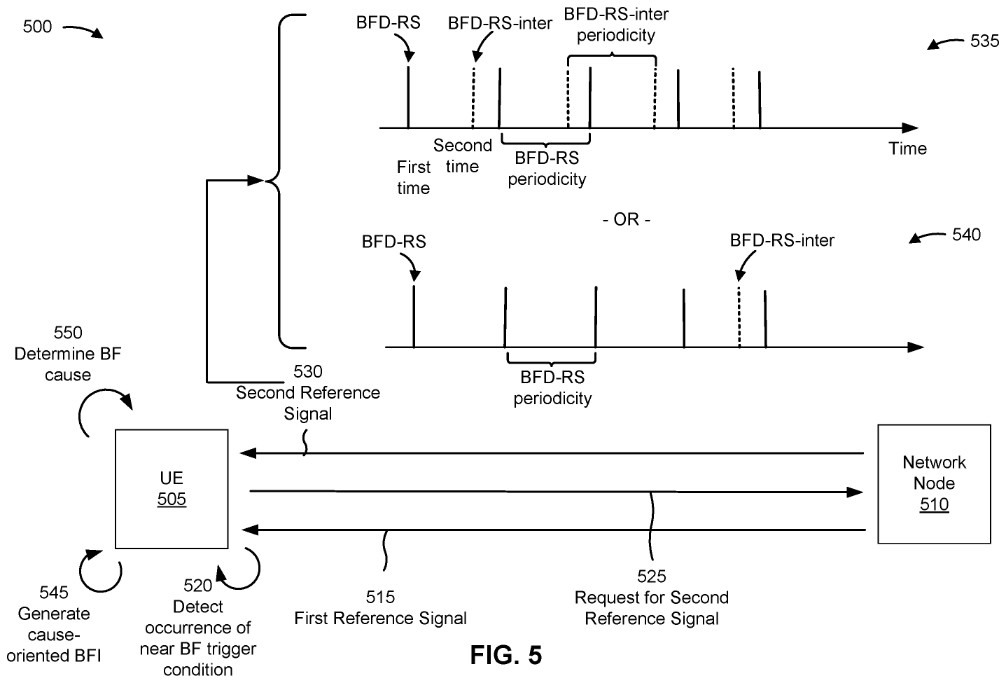

FIG. 5 is a diagram illustrating an example 500 of cause-oriented beam failure indications, in accordance with the present disclosure. As shown in FIG. 5, a UE 505 and a network node 510 may communicate with one another.

As shown by reference number 515, the network node 510 may transmit, and the UE 505 may receive, using a beam, a first reference signal associated with a channel for wireless communication. The first reference signal may include a beam failure detection reference signal. In some aspects, the first reference signal may be a periodic reference signal.

As shown by reference number 520, the UE 505 may detect an occurrence of a near beam failure trigger condition. The UE 505 may detect the occurrence of the near beam failure trigger condition based at least in part on detecting a plurality of beam failure indicators associated with a physical layer of a protocol stack associated with the UE 505. In some aspects, the UE 505 may detect the occurrence of the near beam failure trigger condition based at least in part on determining that a count of beam failure indicators satisfies a threshold.

In some aspects, the UE 505 may receive a first repetition of the first reference signal and may predict that an interference level corresponding to a time period prior to receiving a second repetition of the first reference signal will satisfy an interference threshold. In some aspects, the network node 510 may predict that the interference level corresponding to a time period prior to transmitting a second repetition of the first reference signal will satisfy an interference threshold. As used herein, “repetition” refers to a communication that is transmitted more than one time and refers to the initial transmission of that communication or any subsequent retransmission of that communication.

As shown by reference number 525, the UE 505 may transmit, and the network node 510 may receive, a request for the second reference signal. In some aspects, the UE 505 may transmit the request for the second reference signal based at least in part on detecting the occurrence of the near beam failure trigger condition.

As shown by reference number 530, the network node 510 may transmit, and the UE 505 may receive, using the beam, a second reference signal associated with the channel. In some aspects, the network node 510 may transmit the second reference signal based at least in part on receiving the request for the second reference signal. In some aspects, the network node 510 may transmit the second reference signal based at least in part on predicting that the interference level corresponding to a time period prior to transmitting a second repetition of the first reference signal will satisfy an interference threshold. A characteristic of the second reference signal may include an indication for the UE 505 to determine an interference measurement associated with the second reference signal. The characteristic may include a periodicity of the second reference signal, an aperiodicity of the second reference signal, and/or a sequence of the second reference signal, among other examples. In some aspects, the characteristic may include an instruction to determine the interference measure. The instruction may be encoded into the signal and/or transmitted with the signal. In some aspects, the instruction may be transmitted as part of an RRC configuration and/or dynamically transmitted.

As shown by reference number 535, for example, the second reference signal may include a periodic reference signal. As shown, the UE 505 may receive the first reference signal at a first time and the second reference signal at a second time. The second time may be separated from the first time by a gap. In some aspects, the network node 510 may transmit, and the UE 505 may receive, a gap configuration that indicates a length of the gap. In this way, for example, the UE 505 may identify the second reference signal based at least in part on receiving the second reference signal at the second time (e.g., after the gap). The UE 505 may be indicated to determine an interference measurement associated with the second reference signal implicitly by identifying the second reference signal.

As shown by reference number 540, the second reference signal may include an aperiodic reference signal. As indicated above, the characteristic of the second reference signal that indicates the UE 505 to determine an interference measurement may include an aperiodicity of the second reference signal. For example, in some aspects, the UE 505 may be indicated to determine the interference measurement based at least in part on requesting the second reference signal and/or identifying the second reference signal based at least in part on determining that the second reference signal is aperiodic, among other examples.

As shown by reference number 545, the UE 505 may generate a cause-oriented beam failure indicator based at least in part on a determination that a corresponding measurement satisfies a threshold. In some aspects, the UE 505 may generate the cause-oriented beam failure indicator by generating a first beam failure indicator that indicates a potential failure of the beam based at least in part on a channel quality measurement of the channel, or a second beam failure indicator that indicates a potential failure of the beam based at least in part on interference and an additional channel quality measurement of the channel.

As shown by reference number 550, the UE 505 may determine the beam failure cause associated with the beam. For example, the UE 505 may determine, based at least in part on the first beam failure indicator and/or the second beam failure indicator, that a beam failure has occurred and the cause associated with the beam failure. For example, the UE 505 may determine the beam failure cause based at least in part on at least one of the additional SINR or the interference measurement.

As indicated above, FIG. 5 is provided as an example. Other examples may differ from what is described with respect to FIG. 5.

FIG. 6 is a diagram illustrating an example process 600 performed, for example, by a UE, in accordance with the present disclosure. Example process 600 is an example where the UE (e.g., UE 405) performs operations associated with cause-oriented BFIs.

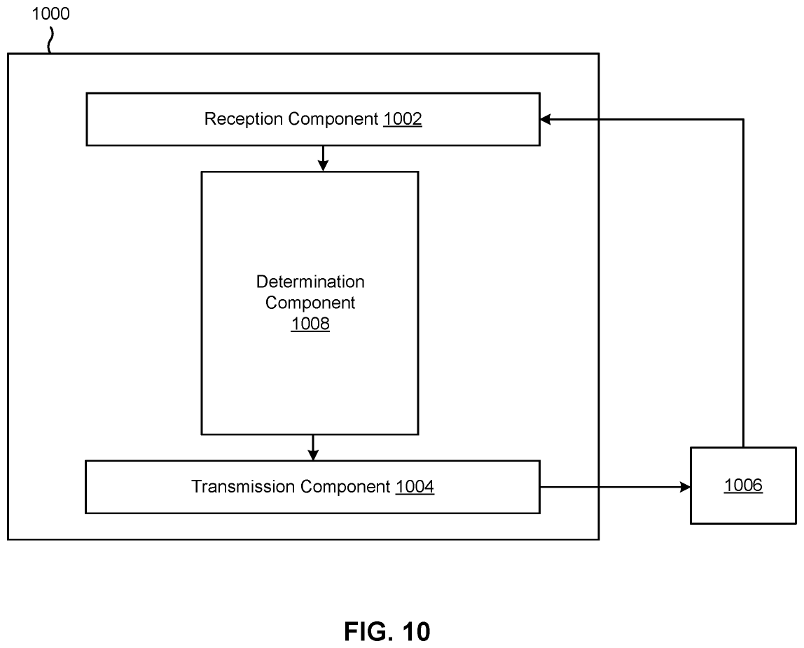

As shown in FIG. 6, in some aspects, process 600 may include receiving, using a beam, a reference signal associated with a channel for wireless communication (block 610). For example, the UE (e.g., using reception component 1002, depicted in FIG. 10) may receive, using a beam, a reference signal associated with a channel for wireless communication, as described above.

As further shown in FIG. 6, in some aspects, process 600 may include generating a cause-oriented BFI based at least in part on a determination of a beam failure cause associated with the beam (block 620). For example, the UE (e.g., using determination component 1008, depicted in FIG. 10) may generate a cause-oriented BFI based at least in part on a determination of a beam failure cause associated with the beam, as described above.

Process 600 may include additional aspects, such as any single aspect or any combination of aspects described below and/or in connection with one or more other processes described elsewhere herein.

In a first aspect, process 600 includes determining the beam failure cause associated with the beam.

In a second aspect, alone or in combination with the first aspect, process 600 includes determining, based at least in part on the reference signal, an SINR associated with the beam, and determining that the SINR satisfies a threshold, wherein determining the beam failure cause comprises determining the beam failure cause based at least in part on determining that the SINR satisfies the threshold.

In a third aspect, alone or in combination with one or more of the first and second aspects, generating the cause-oriented BFI comprises generating a first BFI that indicates a failure of the beam based at least in part on a channel quality of the channel, or a second BFI that indicates a failure of the beam based at least in part on interference.

In a fourth aspect, alone or in combination with one or more of the first through third aspects, process 600 includes determining a channel signal strength, determining an interference power measurement, and determining the beam failure cause based at least in part on the channel signal strength and the interference power measurement.

In a fifth aspect, alone or in combination with one or more of the first through fourth aspects, process 600 includes determining that the channel signal strength satisfies a strength threshold, determining that the interference power measurement satisfies an interference threshold, and generating the second BFI based at least in part on determining that the channel signal strength satisfies the strength threshold and determining that the interference power measurement satisfies the interference threshold.

In a sixth aspect, alone or in combination with one or more of the first through fifth aspects, process 600 includes determining that the channel signal strength fails to satisfy a strength threshold, determining that the interference power measurement satisfies an interference threshold, and generating the first BFI based at least in part on determining that the channel signal strength fails to satisfy the strength threshold and determining that the interference power measurement satisfies the interference threshold.

In a seventh aspect, alone or in combination with one or more of the first through sixth aspects, process 600 includes determining that the channel signal strength fails to satisfy a strength threshold, determining that the interference power measurement fails to satisfy an interference threshold, and generating the first BFI based at least in part on determining that the channel signal strength fails to satisfy the strength threshold and determining that the interference power measurement fails to satisfy the interference threshold.

In an eighth aspect, alone or in combination with one or more of the first through seventh aspects, generating the cause-oriented BFI comprises generating the cause-oriented BFI using a physical protocol layer of the UE.

In a ninth aspect, alone or in combination with one or more of the first through eighth aspects, process 600 includes reporting, using the physical protocol layer, the cause-oriented BFI to a MAC layer of the UE.

In a tenth aspect, alone or in combination with one or more of the first through ninth aspects, generating the cause-oriented BFI comprises generating the cause-oriented BFI using a MAC layer of the UE.

In an eleventh aspect, alone or in combination with one or more of the first through tenth aspects, process 600 includes determining, using a physical layer protocol of the UE, a channel signal strength, determining, using the physical layer protocol of the UE, an interference power measurement, and reporting, using the physical layer protocol of the UE, the channel signal strength and the interference power measurement to the MAC layer of the UE.

In a twelfth aspect, alone or in combination with one or more of the first through eleventh aspects, process 600 includes receiving a cause-oriented BFI configuration.

In a thirteenth aspect, alone or in combination with one or more of the first through twelfth aspects, the cause-oriented BFI configuration indicates at least one of a first BFI that is configured to indicate a failure of the beam based at least in part on a channel quality of the channel, a second BFI that is configured to indicate a failure of the beam based at least in part on interference, a strength threshold, or an interference threshold.

In a fourteenth aspect, alone or in combination with one or more of the first through thirteenth aspects, receiving the cause-oriented BFI configuration comprises receiving an RRC message that includes the cause-oriented BFI configuration.

In a fifteenth aspect, alone or in combination with one or more of the first through fourteenth aspects, the RRC message indicates a set of threshold values associated with at least one of a strength threshold or an interference threshold.

In a sixteenth aspect, alone or in combination with one or more of the first through fifteenth aspects, process 600 includes receiving a threshold switch indication to switch from a first value of the set of threshold values to a second value of the set of threshold values.

In a seventeenth aspect, alone or in combination with one or more of the first through sixteenth aspects, receiving the threshold switch indication comprises receiving at least one of a DCI transmission or a MAC CE.

In an eighteenth aspect, alone or in combination with one or more of the first through seventeenth aspects, the reference signal comprises a dedicated beam failure determination reference signal.

In a nineteenth aspect, alone or in combination with one or more of the first through eighteenth aspects, the reference signal corresponds to one or more reference signal occasions, and process 600 includes receiving an instruction to determine at least one of a channel signal strength or an interference power measurement, wherein the instruction corresponds to at least one of the one or more reference signal occasions.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a diagram illustrating an example process 700 performed, for example, by a UE, in accordance with the present disclosure. Example process 700 is an example where the UE (e.g., UE 505) performs operations associated with multiple reference signals for cause-oriented beam failure determination.

As shown in FIG. 7, in some aspects, process 700 may include receiving, using a beam, a first reference signal associated with a channel for wireless communication (block 710). For example, the UE (e.g., using reception component 1002, depicted in FIG. 10) may receive, using a beam, a first reference signal associated with a channel for wireless communication, as described above.

As further shown in FIG. 7, in some aspects, process 700 may include receiving, using the beam, a second reference signal associated with the channel, wherein a characteristic of the second reference signal comprises an indication for the UE to determine an interference measurement associated with the second reference signal (block 720). For example, the UE (e.g., using reception component 1002, depicted in FIG. 10) may receive, using the beam, a second reference signal associated with the channel, wherein a characteristic of the second reference signal comprises an indication for the UE to determine an interference measurement associated with the second reference signal, as described above.

As further shown in FIG. 7, in some aspects, process 700 may include generating a cause-oriented beam failure indicator based at least in part on the second reference signal (block 730). For example, the UE (e.g., using determination component 1008, depicted in FIG. 10) may generate a cause-oriented beam failure indicator based at least in part on the second reference signal, as described above.

Process 700 may include additional aspects, such as any single aspect or any combination of aspects described below and/or in connection with one or more other processes described elsewhere herein.

In a first aspect, process 700 includes determining the beam failure cause associated with the beam based at least in part on the cause-oriented beam failure indicator.

In a second aspect, alone or in combination with the first aspect, the second reference signal comprises a periodic reference signal.

In a third aspect, alone or in combination with one or more of the first and second aspects, the characteristic of the second reference signal comprises a periodicity of the second reference signal.

In a fourth aspect, alone or in combination with one or more of the first through third aspects, receiving the first reference signal comprises receiving the first reference signal at a first time, wherein receiving the second reference signal comprises receiving the second reference signal at a second time, and wherein the second time is separated from the first time by a gap.

In a fifth aspect, alone or in combination with one or more of the first through fourth aspects, process 700 includes receiving a gap configuration that indicates a length of the gap.

In a sixth aspect, alone or in combination with one or more of the first through fifth aspects, generating the cause-oriented beam failure indicator comprises generating a first beam failure indicator that indicates a failure of the beam based at least in part on a channel quality measurement of the channel, or a second beam failure indicator that indicates a failure of the beam based at least in part on the interference measurement and an additional channel quality measurement.

In a seventh aspect, alone or in combination with one or more of the first through sixth aspects, process 700 includes determining, based at least in part on the first reference signal, the channel quality measurement of the channel, wherein the channel quality measurement comprises an SINR associated with the beam, determining, based at least in part on the second reference signal, the interference measurement and an additional channel quality measurement, wherein the additional channel quality measurement comprises an additional SINR, where generating the cause-oriented beam failure indicator includes generating the cause-oriented beam failure indicator based at least in part on at least one of the additional SINR or the interference measurement.

In an eighth aspect, alone or in combination with one or more of the first through seventh aspects, the first reference signal comprises a periodic reference signal.

In a ninth aspect, alone or in combination with one or more of the first through eighth aspects, the second reference signal comprises an aperiodic reference signal.

In a tenth aspect, alone or in combination with one or more of the first through ninth aspects, the characteristic of the second reference signal comprises an an instruction to measure the interference associated with the second reference signal.

In an eleventh aspect, alone or in combination with one or more of the first through tenth aspects, process 700 includes transmitting a request for the second reference signal, wherein receiving the second reference signal comprises receiving the second reference signal based at least in part on transmitting the request for the second reference signal.

In a twelfth aspect, alone or in combination with one or more of the first through eleventh aspects, process 700 includes detecting an occurrence of a near beam failure trigger condition, wherein transmitting the request for the second reference signal comprises transmitting the request for the second reference signal based at least in part on detecting the occurrence of the near beam failure trigger condition.

In a thirteenth aspect, alone or in combination with one or more of the first through twelfth aspects, detecting the occurrence of the near beam failure trigger condition comprises detecting a plurality of beam failure indicators associated with a physical layer of a protocol stack associated with the UE.

In a fourteenth aspect, alone or in combination with one or more of the first through thirteenth aspects, detecting the occurrence of the near beam failure trigger condition comprises determining that a count of beam failure indicators satisfies a threshold.

In a fifteenth aspect, alone or in combination with one or more of the first through fourteenth aspects, receiving the first reference signal comprises receiving a first repetition of the first reference signal, and detecting the occurrence of the near beam failure trigger condition comprises predicting that an interference level corresponding to a time period prior to receiving a second repetition of the first reference signal will satisfy an interference threshold.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram illustrating an example process 800 performed, for example, by a network node, in accordance with the present disclosure. Example process 800 is an example where the network node (e.g., network node 410) performs operations associated with cause-oriented BFIs.

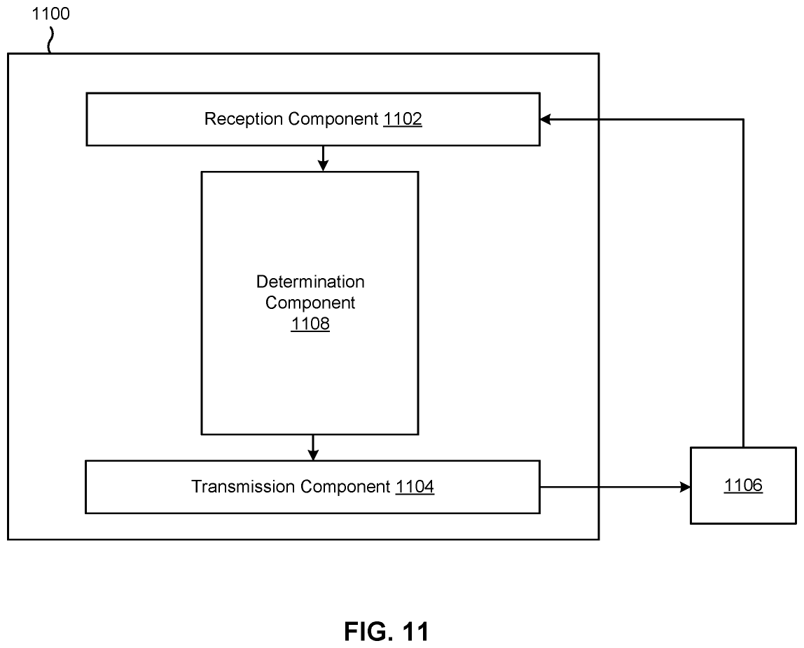

As shown in FIG. 8, in some aspects, process 800 may include transmitting a cause-oriented BFI configuration that indicates a cause-oriented BFI (block 810). For example, the network node (e.g., using transmission component 1104, depicted in FIG. 11) may transmit a cause-oriented BFI configuration that indicates a cause-oriented BFI, as described above.

As further shown in FIG. 8, in some aspects, process 800 may include transmitting a beam failure determination reference signal associated with a channel for wireless communication (block 820). For example, the network node (e.g., using transmission component 1104, depicted in FIG. 11) may transmit a beam failure determination reference signal associated with a channel for wireless communication, as described above.

Process 800 may include additional aspects, such as any single aspect or any combination of aspects described below and/or in connection with one or more other processes described elsewhere herein.

In a first aspect, the cause-oriented BFI comprises a first BFI that indicates a failure of the beam based at least in part on a channel quality of the channel, or a second BFI that indicates a failure of the beam based at least in part on interference.

In a second aspect, alone or in combination with the first aspect, the cause-oriented BFI configuration indicates at least one of the first BFI, the second BFI, a strength threshold, or an interference threshold.

In a third aspect, alone or in combination with one or more of the first and second aspects, transmitting the cause-oriented BFI configuration comprises transmitting an RRC message that includes the cause-oriented BFI configuration.

In a fourth aspect, alone or in combination with one or more of the first through third aspects, the RRC message indicates a set of threshold values associated with at least one of a strength threshold or an interference threshold.

In a fifth aspect, alone or in combination with one or more of the first through fourth aspects, process 800 includes transmitting a threshold switch indication to switch from a first value of the set of threshold values to a second value of the set of threshold values.

In a sixth aspect, alone or in combination with one or more of the first through fifth aspects, transmitting the threshold switch indication comprises transmitting at least one of a DCI transmission or a MAC CE.

In a seventh aspect, alone or in combination with one or more of the first through sixth aspects, the reference signal comprises a dedicated beam failure determination reference signal.

In an eighth aspect, alone or in combination with one or more of the first through seventh aspects, the reference signal corresponds to one or more reference signal occasions, and process 800 includes transmitting an instruction to determine at least one of a channel signal strength or an interference power measurement, wherein the instruction corresponds to at least one of the one or more reference signal occasions.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram illustrating an example process 900 performed, for example, by a network node, in accordance with the present disclosure. Example process 900 is an example where the network node (e.g., network node 510) performs operations associated with multiple reference signals for cause-oriented beam failure determination.

As shown in FIG. 9, in some aspects, process 900 may include transmitting a first reference signal associated with a channel for wireless communication (block 910). For example, the network node (e.g., using transmission component 1104, depicted in FIG. 11) may transmit a first reference signal associated with a channel for wireless communication, as described above.

As further shown in FIG. 9, in some aspects, process 900 may include transmitting a second reference signal associated with the channel, wherein a characteristic of the second reference signal comprises an indication for a UE to determine an interference measurement associated with the second reference signal and corresponding to a cause-oriented beam failure indicator (block 920). For example, the network node (e.g., using transmission component 1104, depicted in FIG. 11) may transmit a second reference signal associated with the channel, wherein a characteristic of the second reference signal comprises an indication for a UE to determine an interference measurement associated with the second reference signal and corresponding to a cause-oriented beam failure indicator, as described above.

Process 900 may include additional aspects, such as any single aspect or any combination of aspects described below and/or in connection with one or more other processes described elsewhere herein.

In a first aspect, the second reference signal comprises a periodic reference signal.

In a second aspect, alone or in combination with the first aspect, the characteristic of the second reference signal comprises a periodicity of the second reference signal.

In a third aspect, alone or in combination with one or more of the first and second aspects, transmitting the first reference signal comprises transmitting the first reference signal at a first time, wherein transmitting the second reference signal comprises transmitting the second reference signal at a second time, and wherein the second time is separated from the first time by a gap.

In a fourth aspect, alone or in combination with one or more of the first through third aspects, process 900 includes transmitting a gap configuration that indicates a length of the gap.

In a fifth aspect, alone or in combination with one or more of the first through fourth aspects, the cause-oriented beam failure indicator comprises a first beam failure indicator that indicates a potential failure of the beam based at least in part on a channel quality measurement of the channel, or a second beam failure indicator that indicates a potential failure of the beam based at least in part on the interference measurement and an additional channel quality measurement of the channel.

In a sixth aspect, alone or in combination with one or more of the first through fifth aspects, the first reference signal comprises a periodic reference signal.

In a seventh aspect, alone or in combination with one or more of the first through sixth aspects, the second reference signal comprises an aperiodic reference signal.

In an eighth aspect, alone or in combination with one or more of the first through seventh aspects, the characteristic of the second reference signal comprises an instruction to measure the interference associated with the second reference signal.

In a ninth aspect, alone or in combination with one or more of the first through eighth aspects, process 900 includes receiving a request for the second reference signal, wherein transmitting the second reference signal comprises transmitting the second reference signal based at least in part on receiving the request for the second reference signal.

In a tenth aspect, alone or in combination with one or more of the first through ninth aspects, receiving the request for the second reference signal comprises receiving the request for the second reference signal based at least in part on a detection of an occurrence of a near beam failure trigger condition.

In an eleventh aspect, alone or in combination with one or more of the first through tenth aspects, the detection of the occurrence of the near beam failure trigger condition comprises detection of a plurality of beam failure indicators associated with a physical layer of a protocol stack associated with the UE.

In a twelfth aspect, alone or in combination with one or more of the first through eleventh aspects, the detection of the occurrence of the near beam failure trigger condition comprises a determination that a count of beam failure indicators satisfies a threshold.

In a thirteenth aspect, alone or in combination with one or more of the first through twelfth aspects, transmitting the first reference signal comprises transmitting a first repetition of the first reference signal, and detection of the occurrence of the near beam failure trigger condition comprises a prediction that an interference level corresponding to a time period prior to transmission of a second repetition of the first reference signal will satisfy an interference threshold.

In a fourteenth aspect, alone or in combination with one or more of the first through thirteenth aspects, process 900 includes predicting that an interference level corresponding to a time period prior to transmission of a second repetition of the first reference signal will satisfy an interference threshold, wherein transmitting the second reference signal includes transmitting the second reference signal based at least in part on predicting that the interference level corresponding to the time period prior to transmission of the second repetition of the first reference signal will satisfy an interference threshold.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a block diagram of an example apparatus 1000 for wireless communication. The apparatus 1000 may be a UE, or a UE may include the apparatus 1000. In some aspects, the apparatus 1000 includes a reception component 1002 and a transmission component 1004, which may be in communication with one another (for example, via one or more buses and/or one or more other components). As shown, the apparatus 1000 may communicate with another apparatus 1006 (such as a UE, a network node, or another wireless communication device) using the reception component 1002 and the transmission component 1004. As further shown, the apparatus 1000 may include a determination component 1008.

In some aspects, the apparatus 1000 may be configured to perform one or more operations described herein in connection with FIGS. 4 and 5. Additionally, or alternatively, the apparatus 1000 may be configured to perform one or more processes described herein, such as process 500 of FIG. 5, process 600 of FIG. 6, or a combination thereof. In some aspects, the apparatus 1000 and/or one or more components shown in FIG. 10 may include one or more components of the UE described above in connection with FIG. 2. Additionally, or alternatively, one or more components shown in FIG. 10 may be implemented within one or more components described above in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1002 may receive communications, such as reference signals, control information, data communications, or a combination thereof, from the apparatus 1006. The reception component 1002 may provide received communications to one or more other components of the apparatus 1000. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1006. In some aspects, the reception component 1002 may include one or more antennas, a demodulator, a MIMO detector, a receive processor, a controller/processor, a memory, or a combination thereof, of the UE described above in connection with FIG. 2.

The transmission component 1004 may transmit communications, such as reference signals, control information, data communications, or a combination thereof, to the apparatus 1006. In some aspects, one or more other components of the apparatus 1006 may generate communications and may provide the generated communications to the transmission component 1004 for transmission to the apparatus 1006. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1006. In some aspects, the transmission component 1004 may include one or more antennas, a modulator, a transmit MIMO processor, a transmit processor, a controller/processor, a memory, or a combination thereof, of the UE described above in connection with FIG. 2. In some aspects, the transmission component 1004 may be co-located with the reception component 1002 in a transceiver.

The reception component 1002 may receive, using a beam, a reference signal associated with a channel for wireless communication. The determination component 1008 may determine the beam failure cause associated with the beam. The determination component 1008 may generate a cause-oriented BFI based at least in part on the determination of the beam failure cause associated with the beam. In some aspects, the determination component 1008 may include one or more antennas, a modulator, a transmit MIMO processor, a transmit processor, a controller/processor, a memory, or a combination thereof, of the UE described above in connection with FIG. 2. In some aspects, the determination component 1008 may include the reception component 1002 and/or the transmission component 1004.

The determination component 1008 may determine, based at least in part on the reference signal, an SINR associated with the beam. The determination component 1008 may determine that the SINR satisfies a threshold, wherein determining the beam failure cause comprises determining the beam failure cause based at least in part on determining that the SINR satisfies the threshold.

The determination component 1008 may determine a channel signal strength. The determination component 1008 may determine an interference power measurement. The determination component 1008 may determine the beam failure cause based at least in part on the channel signal strength and the interference power measurement. The determination component 1008 may determine that the channel signal strength satisfies a strength threshold. The determination component 1008 may determine that the interference power measurement satisfies an interference threshold. The determination component 1008 may generate the second BFI based at least in part on determining that the channel signal strength satisfies the strength threshold and determining that the interference power measurement satisfies the interference threshold.

The determination component 1008 may determine that the channel signal strength fails to satisfy a strength threshold. The determination component 1008 may determine that the interference power measurement satisfies an interference threshold. The determination component may generate the first BFI based at least in part on determining that the channel signal strength fails to satisfy the strength threshold and determining that the interference power measurement satisfies the interference threshold.

The determination component 1008 may determine that the channel signal strength fails to satisfy a strength threshold. The determination component 1008 may determine that the interference power measurement fails to satisfy an interference threshold. The determination component 1008 may generate the first BFI based at least in part on determining that the channel signal strength fails to satisfy the strength threshold and determining that the interference power measurement fails to satisfy the interference threshold.

The determination component 1008 and/or transmission component 1004 may report, using the physical protocol layer, the cause-oriented BFI to a medium access protocol layer of the UE. The determination component 1008 may determine, using a physical layer protocol of the UE, a channel signal strength. The determination component 1008 may determine, using the physical layer protocol of the UE, an interference power measurement. The determination component 1008 and/or transmission component 1004 may report, using the physical layer protocol of the UE, the channel signal strength and the interference power measurement to the MAC layer of the UE.

The reception component 1002 may receive a cause-oriented BFI configuration. The reception component 1002 may receive a threshold switch indication to switch from a first value of the set of threshold values to a second value of the set of threshold values.

The reception component 1002 may receive, using a beam, a first reference signal associated with a channel for wireless communication. The reception component 1002 may receive, using the beam, a second reference signal associated with the channel, wherein a characteristic of the second reference signal comprises an indication for the UE to determine an interference measurement associated with the second reference signal. The reception component 1002 may receive a gap configuration that indicates a length of the gap.

The determination component 1008 may determine the beam failure cause associated with the beam. The determination component may generate a cause-oriented beam failure indicator based at least in part on a determination of a potential beam failure cause associated with the beam. The determination component 1008 may determine, based at least in part on the first reference signal, an SINR associated with the beam. The determination component 1008 may determine, based at least in part on the second reference signal, the interference measurement and an additional SINR. The determination component 1008 may determine the beam failure cause based at least in part on at least one of the additional SINR or the interference measurement.

The transmission component 1004 may transmit a request for the second reference signal, wherein receiving the second reference signal comprises receiving the second reference signal based at least in part on transmitting the request for the second reference signal. The determination component 1008 may detect an occurrence of a near beam failure trigger condition, wherein transmitting the request for the second reference signal comprises transmitting the request for the second reference signal based at least in part on detecting the occurrence of the near beam failure trigger condition.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

FIG. 11 is a block diagram of an example apparatus 1100 for wireless communication. The apparatus 1100 may be a network node, or a network node may include the apparatus 1100. In some aspects, the apparatus 1100 includes a reception component 1102 and a transmission component 1104, which may be in communication with one another (for example, via one or more buses and/or one or more other components). As shown, the apparatus 1100 may communicate with another apparatus 1106 (such as a UE, a base station, or another wireless communication device) using the reception component 1102 and the transmission component 1104. As further shown, the apparatus 1100 may include a determination component 1108.

In some aspects, the apparatus 1100 may be configured to perform one or more operations described herein in connection with FIGS. 4 and 5. Additionally, or alternatively, the apparatus 1100 may be configured to perform one or more processes described herein, such as process 700 of FIG. 7, process 800 of FIG. 8, or a combination thereof. In some aspects, the apparatus 1100 and/or one or more components shown in FIG. 11 may include one or more components of the base station described above in connection with FIG. 2. Additionally, or alternatively, one or more components shown in FIG. 11 may be implemented within one or more components described above in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1102 may receive communications, such as reference signals, control information, data communications, or a combination thereof, from the apparatus 1106. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1106. In some aspects, the reception component 1102 may include one or more antennas, a demodulator, a MIMO detector, a receive processor, a controller/processor, a memory, or a combination thereof, of the base station described above in connection with FIG. 2.

The transmission component 1104 may transmit communications, such as reference signals, control information, data communications, or a combination thereof, to the apparatus 1106. In some aspects, one or more other components of the apparatus 1106 may generate communications and may provide the generated communications to the transmission component 1104 for transmission to the apparatus 1106. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1106. In some aspects, the transmission component 1104 may include one or more antennas, a modulator, a transmit MIMO processor, a transmit processor, a controller/processor, a memory, or a combination thereof, of the base station described above in connection with FIG. 2. In some aspects, the transmission component 1104 may be co-located with the reception component 1102 in a transceiver.

The transmission component 1104 may transmit a cause-oriented BFI configuration that indicates a cause-oriented BFI. The transmission component 1104 may transmit a beam failure determination reference signal associated with a channel for wireless communication. The transmission component 1104 may transmit a threshold switch indication to switch from a first value of the set of threshold values to a second value of the set of threshold values.

The determination component 1108 may determine a cause-oriented beam failure configuration and/or a beam failure determination reference signal configuration, among other examples. In some aspects, the determination component 1108 may include one or more antennas, a demodulator, a MIMO detector, a receive processor, a controller/processor, a memory, or a combination thereof, of the base station described above in connection with FIG. 2. In some aspects, the determination component 1108 may include the reception component 1102 and/or the transmission component 1104.

The transmission component 1104 may transmit a first reference signal associated with a channel for wireless communication. The transmission component 1104 may transmit a second reference signal associated with the channel, wherein a characteristic of the second reference signal comprises an indication for a UE to determine an interference measurement associated with the second reference signal and corresponding to a cause-oriented beam failure indicator. The transmission component 1104 may transmit a gap configuration that indicates a length of the gap.

The reception component 1102 may receive a request for the second reference signal, wherein transmitting the second reference signal comprises transmitting the second reference signal based at least in part on receiving the request for the second reference signal.

The determination component 1108 may determine a reference signal configuration, a gap configuration, and/or a resource allocation, among other examples. For example, the determination component 1108 may predict that an interference level corresponding to a time period prior to transmitting a second repetition of a first reference signal will satisfy an interference threshold.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

The following provides an overview of some Aspects of the present disclosure:

Aspect 1: A method of wireless communication performed by a user equipment (UE), comprising: receiving, using a beam, a reference signal associated with a channel for wireless communication; and generating a cause-oriented beam failure indicator based at least in part on a determination of a beam failure cause associated with the beam.

Aspect 2: The method of Aspect 1, further comprising determining the beam failure cause associated with the beam.

Aspect 3: The method of Aspect 2, further comprising: determining, based at least in part on the reference signal, a signal to interference plus noise ratio (SINR) associated with the beam; and determining that the SINR satisfies a threshold, wherein determining the beam failure cause comprises determining the beam failure cause based at least in part on determining that the SINR satisfies the threshold.

Aspect 4: The method of any of Aspects 1-3, wherein generating the cause-oriented beam failure indicator comprises generating: a first beam failure indicator that indicates a failure of the beam based at least in part on a channel quality of the channel, or a second beam failure indicator that indicates a failure of the beam based at least in part on interference.

Aspect 5: The method of Aspect 4, further comprising: determining a channel signal strength; determining an interference power measurement; and determining the beam failure cause based at least in part on the channel signal strength and the interference power measurement.

Aspect 6: The method of Aspect 5, further comprising: determining that the channel signal strength satisfies a strength threshold; determining that the interference power measurement satisfies an interference threshold; and generating the second beam failure indicator based at least in part on determining that the channel signal strength satisfies the strength threshold and determining that the interference power measurement satisfies the interference threshold.

Aspect 7: The method of Aspect 5, further comprising: determining that the channel signal strength fails to satisfy a strength threshold; determining that the interference power measurement satisfies an interference threshold; and generating the first beam failure indicator based at least in part on determining that the channel signal strength fails to satisfy the strength threshold and determining that the interference power measurement satisfies the interference threshold.

Aspect 8: The method of Aspect 5, further comprising: determining that the channel signal strength fails to satisfy a strength threshold; determining that the interference power measurement fails to satisfy an interference threshold; and generating the first beam failure indicator based at least in part on determining that the channel signal strength fails to satisfy the strength threshold and determining that the interference power measurement fails to satisfy the interference threshold.

Aspect 9: The method of any of Aspects 1-8, wherein generating the cause-oriented beam failure indicator comprises generating the cause-oriented beam failure indicator using a physical protocol layer of the UE.

Aspect 10: The method of Aspect 9, further comprising reporting, using the physical protocol layer, the cause-oriented beam failure indicator to a medium access protocol layer of the UE.

Aspect 11: The method of any of Aspects 1-10, wherein generating the cause-oriented beam failure indicator comprises generating the cause-oriented beam failure indicator using a medium access control (MAC) layer of the UE.

Aspect 12: The method of Aspect 11, further comprising: determining, using a physical layer protocol of the UE, a channel signal strength; determining, using the physical layer protocol of the UE, an interference power measurement; and reporting, using the physical layer protocol of the UE, the channel signal strength and the interference power measurement to the MAC layer of the UE.

Aspect 13: The method of any of Aspects 1-12, further comprising receiving a cause-oriented beam failure indicator configuration.

Aspect 14: The method of Aspect 13, wherein the cause-oriented beam failure indicator configuration indicates at least one of: a first beam failure indicator that is configured to indicate a failure of the beam based at least in part on a channel quality of the channel, a second beam failure indicator that is configured to indicate a failure of the beam based at least in part on interference, a strength threshold, or an interference threshold.

Aspect 15: The method of either of Aspects 13 or 14, wherein receiving the cause-oriented beam failure indicator configuration comprises receiving a radio resource control (RRC) message that includes the cause-oriented beam failure indicator configuration.

Aspect 16: The method of Aspect 15, wherein the RRC message indicates a set of threshold values associated with at least one of a strength threshold or an interference threshold.

Aspect 17: The method of Aspect 16, further comprising receiving a threshold switch indication to switch from a first value of the set of threshold values to a second value of the set of threshold values.

Aspect 18: The method of Aspect 17, wherein receiving the threshold switch indication comprises receiving at least one of a downlink control information transmission or a medium access control control element.

Aspect 19: The method of any of Aspects 1-18, wherein the reference signal comprises a dedicated beam failure determination reference signal.

Aspect 20: The method of any of Aspects 1-19, wherein the reference signal corresponds to one or more reference signal occasions, the method further comprising: receiving an instruction to determine at least one of a channel signal strength or an interference power measurement, wherein the instruction corresponds to at least one of the one or more reference signal occasions.

Aspect 21: A method of wireless communication performed by a network node, comprising: transmitting a cause-oriented beam failure indicator configuration that indicates a cause-oriented beam failure indicator; and transmitting a beam failure determination reference signal associated with a channel for wireless communication.

Aspect 22: The method of Aspect 21, wherein the cause-oriented beam failure indicator comprises: a first beam failure indicator that indicates a failure of the beam based at least in part on a channel quality of the channel, or a second beam failure indicator that indicates a failure of the beam based at least in part on interference.

Aspect 23: The method of Aspect 22, wherein the cause-oriented beam failure indicator configuration indicates at least one of: the first beam failure indicator, the second beam failure indicator, a strength threshold, or an interference threshold.

Aspect 24: The method of any of Aspects 21-23, wherein transmitting the cause-oriented beam failure indicator configuration comprises transmitting a radio resource control (RRC) message that includes the cause-oriented beam failure indicator configuration.

Aspect 25: The method of Aspect 24, wherein the RRC message indicates a set of threshold values associated with at least one of a strength threshold or an interference threshold.

Aspect 26: The method of Aspect 25, further comprising transmitting a threshold switch indication to switch from a first value of the set of threshold values to a second value of the set of threshold values.

Aspect 27: The method of Aspect 26, wherein transmitting the threshold switch indication comprises transmitting at least one of a downlink control information transmission or a medium access control control element.

Aspect 28: The method of any of Aspects 21-27, wherein the reference signal comprises a dedicated beam failure determination reference signal.

Aspect 29: The method of any of Aspects 21-28, wherein the reference signal corresponds to one or more reference signal occasions, the method further comprising: transmitting an instruction to determine at least one of a channel signal strength or an interference power measurement, wherein the instruction corresponds to at least one of the one or more reference signal occasions.

Aspect 30: A method of wireless communication performed by a user equipment (UE), comprising: receiving, using a beam, a first reference signal associated with a channel for wireless communication; receiving, using the beam, a second reference signal associated with the channel, wherein a characteristic of the second reference signal comprises an indication for the UE to determine an interference measurement associated with the second reference signal; and generating a cause-oriented beam failure indicator based at least in part on the second reference signal.

Aspect 31: The method of Aspect 30, further comprising determining the beam failure cause associated with the beam based at least in part on the cause-oriented beam failure indicator.

Aspect 32: The method of either of Aspects 30 or 31, wherein the second reference signal comprises a periodic reference signal.

Aspect 33: The method of any of Aspects 30-32, wherein the characteristic of the second reference signal comprises a periodicity of the second reference signal.

Aspect 34: The method of any of Aspects 30-33, wherein receiving the first reference signal comprises receiving the first reference signal at a first time, wherein receiving the second reference signal comprises receiving the second reference signal at a second time, and wherein the second time is separated from the first time by a gap.

Aspect 35: The method of Aspect 34, further comprising receiving a gap configuration that indicates a length of the gap.

Aspect 36: The method of any of Aspects 30-35, wherein generating the cause-oriented beam failure indicator comprises generating: a first beam failure indicator that indicates a potential failure of the beam based at least in part on a channel quality measurement of the channel, or a second beam failure indicator that indicates a potential failure of the beam based at least in part on the interference measurement and an additional channel quality measurement.

Aspect 37: The method of Aspect 36, further comprising: determining, based at least in part on the first reference signal, the channel quality measurement of the channel, wherein the channel quality measurement comprises a signal to interference plus noise ratio (SINK) associated with the beam; and determining, based at least in part on the second reference signal, the interference measurement and an additional channel quality measurement, wherein the additional channel quality measurement comprises an additional SINR, wherein generating the cause-oriented beam failure indicator comprises generating the cause-oriented beam failure indicator based at least in part on at least one of the additional SINK or the interference measurement.

Aspect 38: The method of any of Aspects 30-37, wherein the first reference signal comprises a periodic reference signal.

Aspect 39: The method of any of Aspects 30-38, wherein the second reference signal comprises an aperiodic reference signal.

Aspect 40: The method of Aspect 39, wherein the characteristic of the second reference signal comprises an instruction to measure the interference associated with the second reference signal.

Aspect 41: The method of any of Aspects 30-40, further comprising transmitting a request for the second reference signal, wherein receiving the second reference signal comprises receiving the second reference signal based at least in part on transmitting the request for the second reference signal.

Aspect 42: The method of Aspect 41, further comprising detecting an occurrence of a near beam failure trigger condition, wherein transmitting the request for the second reference signal comprises transmitting the request for the second reference signal based at least in part on detecting the occurrence of the near beam failure trigger condition.

Aspect 43: The method of Aspect 42, wherein detecting the occurrence of the near beam failure trigger condition comprises detecting a plurality of beam failure indicators associated with a physical layer of a protocol stack associated with the UE.

Aspect 44: The method of either of Aspects 42 or 43, wherein detecting the occurrence of the near beam failure trigger condition comprises determining that a count of beam failure indicators satisfies a threshold.

Aspect 45: The method of any of Aspects 42-44, wherein receiving the first reference signal comprises receiving a first repetition of the first reference signal, and wherein detecting the occurrence of the near beam failure trigger condition comprises predicting that an interference level corresponding to a time period prior to receiving a second repetition of the first reference signal will satisfy an interference threshold.

Aspect 46: A method of wireless communication performed by a network node, comprising: transmitting a first reference signal associated with a channel for wireless communication; and transmitting a second reference signal associated with the channel, wherein a characteristic of the second reference signal comprises an indication for a user equipment (UE) to determine an interference measurement associated with the second reference signal and corresponding to a cause-oriented beam failure indicator.

Aspect 47: The method of Aspect 46, wherein the second reference signal comprises a periodic reference signal.

Aspect 48: The method of either of Aspects 46 or 47, wherein the characteristic of the second reference signal comprises a periodicity of the second reference signal.

Aspect 49: The method of any of Aspects 46-48, wherein transmitting the first reference signal comprises transmitting the first reference signal at a first time, wherein transmitting the second reference signal comprises transmitting the second reference signal at a second time, and wherein the second time is separated from the first time by a gap.

Aspect 50: The method of Aspect 49, further comprising transmitting a gap configuration that indicates a length of the gap.

Aspect 51: The method of any of Aspects 46-50, wherein the cause-oriented beam failure indicator comprises: a first beam failure indicator that indicates a potential failure of the beam based at least in part on a channel quality measurement of the channel, or a second beam failure indicator that indicates a potential failure of the beam based at least in part on the interference measurement and an additional channel quality measurement of the channel.

Aspect 52: The method of any of Aspects 46-51, wherein the first reference signal comprises a periodic reference signal.

Aspect 53: The method of any of Aspects 46-52, wherein the second reference signal comprises an aperiodic reference signal.

Aspect 54: The method of Aspect 53, wherein the characteristic of the second reference signal comprises an instruction to measure the interference associated with the second reference signal.

Aspect 55: The method of any of Aspects 46-54, further comprising receiving a request for the second reference signal, wherein transmitting the second reference signal comprises transmitting the second reference signal based at least in part on receiving the request for the second reference signal.

Aspect 56: The method of Aspect 55, wherein receiving the request for the second reference signal comprises receiving the request for the second reference signal based at least in part on a detection of an occurrence of a near beam failure trigger condition.

Aspect 57: The method of Aspect 56, wherein the detection of the occurrence of the near beam failure trigger condition comprises detection of a plurality of beam failure indicators associated with a physical layer of a protocol stack associated with the UE.

Aspect 58: The method of either of Aspects 56 or 57, wherein the detection of the occurrence of the near beam failure trigger condition comprises a determination that a count of beam failure indicators satisfies a threshold.

Aspect 59: The method of any of Aspects 56-58, wherein transmitting the first reference signal comprises transmitting a first repetition of the first reference signal, and wherein detection of the occurrence of the near beam failure trigger condition comprises a prediction that an interference level corresponding to a time period prior to transmission of a second repetition of the first reference signal will satisfy an interference threshold.

Aspect 60: The method of any of Aspects 46-59, further comprising: predicting that an interference level corresponding to a time period prior to transmission of a second repetition of the first reference signal will satisfy an interference threshold, wherein transmitting the second reference signal comprises transmitting the second reference signal based at least in part on predicting that the interference level corresponding to the time period prior to transmission of the second repetition of the first reference signal will satisfy the interference threshold.

Aspect 61: A method of wireless communication performed by a user equipment (UE), comprising: receiving, using a beam, a first reference signal associated with a channel for wireless communication; and generating a cause-oriented beam failure indicator based at least in part on a determination of a beam failure cause associated with the beam.

Aspect 62: The method of Aspect 61, further comprising determining the beam failure cause associated with the beam.

Aspect 63: The method of Aspect 62, wherein determining the beam failure cause associated with the beam comprises determining the beam failure cause associated with the beam based at least in part on the cause-oriented beam failure indicator.

Aspect 64: The method of either of Aspect 62 or 63, further comprising: determining, based at least in part on the first reference signal, a signal to interference plus noise ratio (SINR) associated with the beam; and determining that the SINR satisfies a threshold, wherein determining the beam failure cause comprises determining the beam failure cause based at least in part on determining that the SINR satisfies the threshold.

Aspect 65: The method of any of Aspects 61-64, wherein generating the cause-oriented beam failure indicator comprises generating: a first beam failure indicator that indicates a failure of the beam based at least in part on a channel quality of the channel, or a second beam failure indicator that indicates a failure of the beam based at least in part on interference.

Aspect 66: The method of Aspect 65, further comprising: determining a channel signal strength; determining an interference power measurement; and determining the beam failure cause based at least in part on the channel signal strength and the interference power measurement.

Aspect 67: The method of Aspect 66, further comprising: determining that the channel signal strength satisfies a strength threshold; determining that the interference power measurement satisfies an interference threshold; and generating the second beam failure indicator based at least in part on determining that the channel signal strength satisfies the strength threshold and determining that the interference power measurement satisfies the interference threshold.

Aspect 68: The method of Aspect 66, further comprising: determining that the channel signal strength fails to satisfy a strength threshold; determining that the interference power measurement satisfies an interference threshold; and generating the first beam failure indicator based at least in part on determining that the channel signal strength fails to satisfy the strength threshold and determining that the interference power measurement satisfies the interference threshold.

Aspect 69: The method of Aspect 66, further comprising: determining that the channel signal strength fails to satisfy a strength threshold; determining that the interference power measurement fails to satisfy an interference threshold; and generating the first beam failure indicator based at least in part on determining that the channel signal strength fails to satisfy the strength threshold and determining that the interference power measurement fails to satisfy the interference threshold.

Aspect 70: The method of any of Aspects 61-69, wherein generating the cause-oriented beam failure indicator comprises generating the cause-oriented beam failure indicator using a physical protocol layer of the UE.

Aspect 71: The method of Aspect 70, further comprising reporting, using the physical protocol layer, the cause-oriented beam failure indicator to a medium access protocol layer of the UE.

Aspect 72: The method of any of Aspects 61-71, wherein generating the cause-oriented beam failure indicator comprises generating the cause-oriented beam failure indicator using a medium access control (MAC) layer of the UE.

Aspect 73: The method of Aspect 72, further comprising: determining, using a physical layer protocol of the UE, a channel signal strength; determining, using the physical layer protocol of the UE, an interference power measurement; and reporting, using the physical layer protocol of the UE, the channel signal strength and the interference power measurement to the MAC layer of the UE.

Aspect 74: The method of any of Aspects 61-64, further comprising receiving a cause-oriented beam failure indicator configuration.

Aspect 75: The method of Aspect 74, wherein the cause-oriented beam failure indicator configuration indicates at least one of: a first beam failure indicator that is configured to indicate a failure of the beam based at least in part on a channel quality of the channel, a second beam failure indicator that is configured to indicate a failure of the beam based at least in part on interference, a strength threshold, or an interference threshold.

Aspect 76: The method of either of Aspects 74 or 75, wherein receiving the cause-oriented beam failure indicator configuration comprises receiving a radio resource control (RRC) message that includes the cause-oriented beam failure indicator configuration.

Aspect 77: The method of Aspect 76, wherein the RRC message indicates a set of threshold values associated with at least one of a strength threshold or an interference threshold.

Aspect 78: The method of Aspect 77, further comprising receiving a threshold switch indication to switch from a first value of the set of threshold values to a second value of the set of threshold values.

Aspect 79: The method of Aspect 78, wherein receiving the threshold switch indication comprises receiving at least one of a downlink control information transmission or a medium access control control element.

Aspect 80: The method of any of Aspects 61-79, wherein the reference signal comprises a dedicated beam failure determination reference signal.

Aspect 81: The method of any of Aspects 61-80, wherein the reference signal corresponds to one or more reference signal occasions, the method further comprising: receiving an instruction to determine at least one of a channel signal strength or an interference power measurement, wherein the instruction corresponds to at least one of the one or more reference signal occasions.

Aspect 82: The method of any of Aspects 61-81, further comprising receiving, using the beam, a second reference signal associated with the channel, wherein a characteristic of the second reference signal comprises an indication for the UE to determine an interference measurement associated with the second reference signal, wherein generating the cause-oriented beam failure indicator comprises generating the cause-oriented beam failure indicator based at least in part on the second reference signal.

Aspect 83: The method of Aspect 82, wherein the second reference signal comprises a periodic reference signal.

Aspect 84: The method of either of Aspects 82 or 83, wherein the characteristic of the second reference signal comprises a periodicity of the second reference signal.

Aspect 85: The method of any of Aspects 82-84, wherein receiving the first reference signal comprises receiving the first reference signal at a first time, wherein receiving the second reference signal comprises receiving the second reference signal at a second time, and wherein the second time is separated from the first time by a gap.

Aspect 86: The method of Aspect 85, further comprising receiving a gap configuration that indicates a length of the gap.

Aspect 87: The method of any of Aspects 82-86, wherein generating the cause-oriented beam failure indicator comprises generating: a first beam failure indicator that indicates a potential failure of the beam based at least in part on a channel quality measurement of the channel, or a second beam failure indicator that indicates a potential failure of the beam based at least in part on the interference measurement and an additional channel quality measurement.

Aspect 88: The method of Aspect 87, further comprising: determining, based at least in part on the first reference signal, the channel quality measurement of the channel, wherein the channel quality measurement comprises a signal to interference plus noise ratio (SINR) associated with the beam; and determining, based at least in part on the second reference signal, the interference measurement and an additional channel quality measurement, wherein the additional channel quality measurement comprises an additional SINR, wherein generating the cause-oriented beam failure indicator comprises generating the cause-oriented beam failure indicator based at least in part on at least one of the additional SINR or the interference measurement.

Aspect 89: The method of any of Aspects 82-89, wherein the first reference signal comprises a periodic reference signal.

Aspect 90: The method of any of Aspects 82-89, wherein the second reference signal comprises an aperiodic reference signal.

Aspect 91: The method of Aspect 90, wherein the characteristic of the second reference signal comprises an instruction to measure the interference associated with the second reference signal.

Aspect 92: The method of any of Aspects 82-91, further comprising transmitting a request for the second reference signal, wherein receiving the second reference signal comprises receiving the second reference signal based at least in part on transmitting the request for the second reference signal.

Aspect 93: The method of Aspect 92, further comprising detecting an occurrence of a near beam failure trigger condition, wherein transmitting the request for the second reference signal comprises transmitting the request for the second reference signal based at least in part on detecting the occurrence of the near beam failure trigger condition.

Aspect 94: The method of Aspect 93, wherein detecting the occurrence of the near beam failure trigger condition comprises detecting a plurality of beam failure indicators associated with a physical layer of a protocol stack associated with the UE.

Aspect 95: The method of either of Aspects 93 or 94, wherein detecting the occurrence of the near beam failure trigger condition comprises determining that a count of beam failure indicators satisfies a threshold.

Aspect 96: The method of any of Aspects 93-95, wherein receiving the first reference signal comprises receiving a first repetition of the first reference signal, and wherein detecting the occurrence of the near beam failure trigger condition comprises predicting that an interference level corresponding to a time period prior to receiving a second repetition of the first reference signal will satisfy an interference threshold.

Aspect 97: A method of wireless communication performed by a network node, comprising: transmitting a cause-oriented beam failure indicator configuration that indicates a cause-oriented beam failure indicator; and transmitting a first reference signal associated with a channel for wireless communication.

Aspect 98: The method of Aspect 97, wherein the cause-oriented beam failure indicator comprises: a first beam failure indicator that indicates a failure of the beam based at least in part on a channel quality of the channel, or a second beam failure indicator that indicates a failure of the beam based at least in part on interference.

Aspect 99: The method of Aspect 98, wherein the cause-oriented beam failure indicator configuration indicates at least one of: the first beam failure indicator, the second beam failure indicator, a strength threshold, or an interference threshold.

Aspect 100: The method of any of Aspects 97-99, wherein transmitting the cause-oriented beam failure indicator configuration comprises transmitting a radio resource control (RRC) message that includes the cause-oriented beam failure indicator configuration.

Aspect 101: The method of Aspect 100, wherein the RRC message indicates a set of threshold values associated with at least one of a strength threshold or an interference threshold.

Aspect 102: The method of Aspect 101, further comprising transmitting a threshold switch indication to switch from a first value of the set of threshold values to a second value of the set of threshold values.

Aspect 103: The method of Aspect 102, wherein transmitting the threshold switch indication comprises transmitting at least one of a downlink control information transmission or a medium access control control element.

Aspect 104: The method of any of Aspects 97-103, wherein the reference signal comprises a dedicated beam failure determination reference signal.

Aspect 105: The method of any of Aspects 97-104, wherein the reference signal corresponds to one or more reference signal occasions, the method further comprising: transmitting an instruction to determine at least one of a channel signal strength or an interference power measurement, wherein the instruction corresponds to at least one of the one or more reference signal occasions.

Aspect 106: The method of any of Aspects 97-105, further comprising transmitting a second reference signal associated with the channel, wherein a characteristic of the second reference signal comprises an indication for a user equipment (UE) to determine an interference measurement associated with the second reference signal and corresponding to a cause-oriented beam failure indicator.

Aspect 107: The method of Aspect 106, wherein the second reference signal comprises a periodic reference signal.

Aspect 108: The method of either of Aspects 106 or 107, wherein the characteristic of the second reference signal comprises a periodicity of the second reference signal.

Aspect 109: The method of any of Aspects 106-108, wherein transmitting the first reference signal comprises transmitting the first reference signal at a first time, wherein transmitting the second reference signal comprises transmitting the second reference signal at a second time, and wherein the second time is separated from the first time by a gap.

Aspect 110: The method of Aspect 109, further comprising transmitting a gap configuration that indicates a length of the gap.

Aspect 111: The method of any of Aspects 106-110, wherein the cause-oriented beam failure indicator comprises: a first beam failure indicator that indicates a potential failure of the beam based at least in part on a channel quality measurement of the channel, or a second beam failure indicator that indicates a potential failure of the beam based at least in part on the interference measurement and an additional channel quality measurement of the channel.

Aspect 112: The method of any of Aspects 106-111, wherein the first reference signal comprises a periodic reference signal.

Aspect 113: The method of any of Aspects 106-111, wherein the second reference signal comprises an aperiodic reference signal.

Aspect 114: The method of Aspect 113, wherein the characteristic of the second reference signal comprises an instruction to measure the interference associated with the second reference signal.

Aspect 115: The method of any of Aspects 106-114, further comprising receiving a request for the second reference signal, wherein transmitting the second reference signal comprises transmitting the second reference signal based at least in part on receiving the request for the second reference signal.

Aspect 116: The method of Aspect 115, wherein receiving the request for the second reference signal comprises receiving the request for the second reference signal based at least in part on a detection of an occurrence of a near beam failure trigger condition.

Aspect 117: The method of Aspect 116, wherein the detection of the occurrence of the near beam failure trigger condition comprises detection of a plurality of beam failure indicators associated with a physical layer of a protocol stack associated with the UE.

Aspect 118: The method of either of Aspects 116 or 117, wherein the detection of the occurrence of the near beam failure trigger condition comprises a determination that a count of beam failure indicators satisfies a threshold.

Aspect 119: The method of any of Aspects 116-118, wherein transmitting the first reference signal comprises transmitting a first repetition of the first reference signal, and wherein detection of the occurrence of the near beam failure trigger condition comprises a prediction that an interference level corresponding to a time period prior to transmission of a second repetition of the first reference signal will satisfy an interference threshold.

Aspect 120: The method of any of Aspects 106-119, further comprising: predicting that an interference level corresponding to a time period prior to transmission of a second repetition of the first reference signal will satisfy an interference threshold, wherein transmitting the second reference signal comprises transmitting the second reference signal based at least in part on predicting that the interference level corresponding to the time period prior to transmission of the second repetition of the first reference signal will satisfy the interference threshold.

Aspect 121: An apparatus for wireless communication at a device, comprising a processor; memory coupled with the processor; and instructions stored in the memory and executable by the processor to cause the apparatus to perform the method of one or more of Aspects 1-20.

Aspect 122: A device for wireless communication, comprising a memory and one or more processors coupled to the memory, the one or more processors configured to perform the method of one or more of Aspects 1-20.

Aspect 123: An apparatus for wireless communication, comprising at least one means for performing the method of one or more of Aspects 1-20.

Aspect 124: A non-transitory computer-readable medium storing code for wireless communication, the code comprising instructions executable by a processor to perform the method of one or more of Aspects 1-20.

Aspect 125: A non-transitory computer-readable medium storing a set of instructions for wireless communication, the set of instructions comprising one or more instructions that, when executed by one or more processors of a device, cause the device to perform the method of one or more of Aspects 1-20.

Aspect 126: An apparatus for wireless communication at a device, comprising a processor; memory coupled with the processor; and instructions stored in the memory and executable by the processor to cause the apparatus to perform the method of one or more of Aspects 21-29.

Aspect 127: A device for wireless communication, comprising a memory and one or more processors coupled to the memory, the one or more processors configured to perform the method of one or more of Aspects 21-29.

Aspect 128: An apparatus for wireless communication, comprising at least one means for performing the method of one or more of Aspects 21-29.

Aspect 129: A non-transitory computer-readable medium storing code for wireless communication, the code comprising instructions executable by a processor to perform the method of one or more of Aspects 21-29.

Aspect 130: A non-transitory computer-readable medium storing a set of instructions for wireless communication, the set of instructions comprising one or more instructions that, when executed by one or more processors of a device, cause the device to perform the method of one or more of Aspects 21-29.

Aspect 131: An apparatus for wireless communication at a device, comprising a processor; memory coupled with the processor; and instructions stored in the memory and executable by the processor to cause the apparatus to perform the method of one or more of Aspects 30-45.

Aspect 132: A device for wireless communication, comprising a memory and one or more processors coupled to the memory, the one or more processors configured to perform the method of one or more of Aspects 30-45.

Aspect 133: An apparatus for wireless communication, comprising at least one means for performing the method of one or more of Aspects 30-45.

Aspect 134: A non-transitory computer-readable medium storing code for wireless communication, the code comprising instructions executable by a processor to perform the method of one or more of Aspects 30-45.

Aspect 135: A non-transitory computer-readable medium storing a set of instructions for wireless communication, the set of instructions comprising one or more instructions that, when executed by one or more processors of a device, cause the device to perform the method of one or more of Aspects 30-45.

Aspect 136: An apparatus for wireless communication at a device, comprising a processor; memory coupled with the processor; and instructions stored in the memory and executable by the processor to cause the apparatus to perform the method of one or more of Aspects 46-60.

Aspect 137: A device for wireless communication, comprising a memory and one or more processors coupled to the memory, the one or more processors configured to perform the method of one or more of Aspects 46-60.

Aspect 138: An apparatus for wireless communication, comprising at least one means for performing the method of one or more of Aspects 46-60.

Aspect 139: A non-transitory computer-readable medium storing code for wireless communication, the code comprising instructions executable by a processor to perform the method of one or more of Aspects 46-60.

Aspect 140: A non-transitory computer-readable medium storing a set of instructions for wireless communication, the set of instructions comprising one or more instructions that, when executed by one or more processors of a device, cause the device to perform the method of one or more of Aspects 46-60.

Aspect 141: An apparatus for wireless communication at a device, comprising a processor; memory coupled with the processor; and instructions stored in the memory and executable by the processor to cause the apparatus to perform the method of one or more of Aspects 61-96.

Aspect 142: A device for wireless communication, comprising a memory and one or more processors coupled to the memory, the one or more processors configured to perform the method of one or more of Aspects 61-96.

Aspect 143: An apparatus for wireless communication, comprising at least one means for performing the method of one or more of Aspects 61-96.

Aspect 144: A non-transitory computer-readable medium storing code for wireless communication, the code comprising instructions executable by a processor to perform the method of one or more of Aspects 61-96.

Aspect 145: A non-transitory computer-readable medium storing a set of instructions for wireless communication, the set of instructions comprising one or more instructions that, when executed by one or more processors of a device, cause the device to perform the method of one or more of Aspects 61-96.

Aspect 146: An apparatus for wireless communication at a device, comprising a processor; memory coupled with the processor; and instructions stored in the memory and executable by the processor to cause the apparatus to perform the method of one or more of Aspects 97-120.

Aspect 147: A device for wireless communication, comprising a memory and one or more processors coupled to the memory, the one or more processors configured to perform the method of one or more of Aspects 97-120.

Aspect 148: An apparatus for wireless communication, comprising at least one means for performing the method of one or more of Aspects 97-120.

Aspect 149: A non-transitory computer-readable medium storing code for wireless communication, the code comprising instructions executable by a processor to perform the method of one or more of Aspects 97-120.

Aspect 150: A non-transitory computer-readable medium storing a set of instructions for wireless communication, the set of instructions comprising one or more instructions that, when executed by one or more processors of a device, cause the device to perform the method of one or more of Aspects 97-120.

The foregoing disclosure provides illustration and description, but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a processor is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods were described herein without reference to specific software code—it being understood that software and hardware can be designed to implement the systems and/or methods based, at least in part, on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A user equipment (UE) for wireless communication, comprising:
a memory; and
one or more processors, coupled to the memory, configured to:
receive, using a beam, a first reference signal associated with a channel for wireless communication; and
generate a cause-oriented beam failure indicator based at least in part on a determination of a beam failure cause associated with the beam.

2. The UE of claim 1, wherein the one or more processors are further configured to determine the beam failure cause associated with the beam.

3. The UE of claim 2, wherein the one or more processors are further configured to:
determine, based at least in part on the first reference signal, a signal-to-interference-plus-noise ratio (SINR) associated with the beam; and
determine that the SINR satisfies a threshold,
wherein the one or more processors, to determine the beam failure cause, are configured to determine the beam failure cause based at least in part on determining that the SINR satisfies the threshold.

4. The UE of claim 1, wherein the one or more processors, to generate the cause-oriented beam failure indicator, are configured to generate:
a first beam failure indicator that indicates a failure of the beam based at least in part on a channel quality of the channel, or
a second beam failure indicator that indicates a failure of the beam based at least in part on interference.

5. The UE of claim 4, wherein the one or more processors are further configured to:
determine a channel signal strength;
determine an interference power measurement;
determine the beam failure cause based at least in part on the channel signal strength and the interference power measurement;
determine that the channel signal strength satisfies a strength threshold;
determine that the interference power measurement satisfies an interference threshold; and
generate the second beam failure indicator based at least in part on determining that the channel signal strength satisfies the strength threshold and determining that the interference power measurement satisfies the interference threshold.

6. The UE of claim 4, wherein the one or more processors are further configured to:
determine a channel signal strength;
determine an interference power measurement;
determine the beam failure cause based at least in part on the channel signal strength and the interference power measurement;
determine that the channel signal strength fails to satisfy a strength threshold;
determine that the interference power measurement satisfies an interference threshold; and
generate the first beam failure indicator based at least in part on determining that the channel signal strength fails to satisfy the strength threshold and determining that the interference power measurement satisfies the interference threshold.

7. The UE of claim 4, wherein the one or more processors are further configured to:
determine a channel signal strength;
determine an interference power measurement;
determine the beam failure cause based at least in part on the channel signal strength and the interference power measurement;
determine that the channel signal strength fails to satisfy a strength threshold;
determine that the interference power measurement fails to satisfy an interference threshold; and
generate the first beam failure indicator based at least in part on determining that the channel signal strength fails to satisfy the strength threshold and determining that the interference power measurement fails to satisfy the interference threshold.

8. The UE of claim 1, wherein the one or more processors, to generate the cause-oriented beam failure indicator, are configured to generate the cause-oriented beam failure indicator using a physical protocol layer of the UE, and wherein the one or more processors are further configured to report, using the physical protocol layer, the cause-oriented beam failure indicator to a medium access protocol layer of the UE.

9. The UE of claim 8, wherein the one or more processors, to generate the cause-oriented beam failure indicator, are configured to generate the cause-oriented beam failure indicator using a medium access control (MAC) layer of the UE, and wherein the one or more processors are further configured to:
determine, using a physical layer protocol of the UE, a channel signal strength;
determine, using the physical layer protocol of the UE, an interference power measurement; and
report, using the physical layer protocol of the UE, the channel signal strength and the interference power measurement to the MAC layer of the UE.

10. The UE of claim 1, wherein the one or more processors are further configured to receive a cause-oriented beam failure indicator configuration, wherein the cause-oriented beam failure indicator configuration indicates at least one of:
a first beam failure indicator that is configured to indicate a failure of the beam based at least in part on a channel quality of the channel,
a second beam failure indicator that is configured to indicate a failure of the beam based at least in part on interference,
a strength threshold, or
an interference threshold.

11. The UE of claim 10, wherein receiving the cause-oriented beam failure indicator configuration comprises receiving a radio resource control (RRC) message that includes the cause-oriented beam failure indicator configuration, wherein the RRC message indicates a set of threshold values associated with at least one of a strength threshold or an interference threshold.

12. The UE of claim 11, wherein the one or more processors are further configured to receive a threshold switch indication to switch from a first value of the set of threshold values to a second value of the set of threshold values, and wherein the one or more processors, to receive the threshold switch indication, are configured to receive at least one of a downlink control information transmission or a medium access control control element.

13. The UE of claim 1, wherein the first reference signal comprises a dedicated beam failure determination reference signal.

14. The UE of claim 1, wherein the first reference signal corresponds to one or more reference signal occasions, and wherein the one or more processors are further configured to:
receive an instruction to determine at least one of a channel signal strength or an interference power measurement, wherein the instruction corresponds to at least one of the one or more reference signal occasions.

15. The UE of claim 1, wherein the one or more processors are further configured to receive, using the beam, a second reference signal associated with the channel, wherein a characteristic of the second reference signal comprises an indication for the UE to determine an interference measurement associated with the second reference signal,
wherein the one or more processors, to generate the cause-oriented beam failure indicator, are configured to generate the cause-oriented beam failure indicator based at least in part on the second reference signal.

16. The UE of claim 15, wherein at least one of the first reference signal or the second reference signal comprises a periodic reference signal.

17. The UE of claim 15, wherein the characteristic of the second reference signal comprises a periodicity of the second reference signal.

18. The UE of claim 15, wherein receiving the first reference signal comprises receiving the first reference signal at a first time, wherein the one or more processors, to receive the second reference signal, are configured to receive the second reference signal at a second time, wherein the second time is separated from the first time by a gap, and wherein the one or more processors are further configured to receive a gap configuration that indicates a length of the gap.

19. The UE of claim 15, wherein the one or more processors, to generate the cause-oriented beam failure indicator, are configured to generate:
a first beam failure indicator that indicates a potential failure of the beam based at least in part on a channel quality measurement of the channel, or
a second beam failure indicator that indicates a potential failure of the beam based at least in part on the interference measurement and an additional channel quality measurement.

20. The UE of claim 19, wherein the one or more processors are further configured to:
determine, based at least in part on the first reference signal, the channel quality measurement of the channel, wherein the channel quality measurement comprises a signal-to-interference-plus-noise ratio (SINR) associated with the beam; and
determine, based at least in part on the second reference signal, the interference measurement and an additional channel quality measurement, wherein the additional channel quality measurement comprises an additional SINR,
wherein the one or more processors, to generate the cause-oriented beam failure indicator, are configured to generate the cause-oriented beam failure indicator based at least in part on at least one of the additional SINR or the interference measurement.

21. The UE of claim 15, wherein the second reference signal comprises an aperiodic reference signal, wherein the characteristic of the second reference signal comprises an instruction to measure the interference measurement associated with the second reference signal.

22. The UE of claim 15, wherein the one or more processors are further configured to:
detect an occurrence of a near beam failure trigger condition based at least in part on detecting the occurrence of the near beam failure trigger condition; and
transmit a request for the second reference signal, wherein the one or more processors, to receive the second reference signal, are configured to receive the second reference signal based at least in part on transmitting the request for the second reference signal.

23. The UE of claim 22, wherein the one or more processors, to detect the occurrence of the near beam failure trigger condition, are configured to:
detect a plurality of beam failure indicators associated with a physical layer of a protocol stack associated with the UE, or
determine that a count of beam failure indicators satisfies a threshold.

24. The UE of claim 22, wherein receiving the first reference signal comprises receiving a first repetition of the first reference signal, and wherein the one or more processors, to detect the occurrence of the near beam failure trigger condition, are configured to predict that an interference level corresponding to a time period prior to receiving a second repetition of the first reference signal will satisfy an interference threshold.

25. A network node for wireless communication, comprising:
a memory; and
one or more processors, coupled to the memory, configured to:
transmit a cause-oriented beam failure indicator configuration that indicates a cause-oriented beam failure indicator, wherein the cause-oriented beam failure indicator comprises:
a first beam failure indicator that indicates a failure of a beam based at least in part on a channel quality of a channel, or
a second beam failure indicator that indicates a failure of the beam based at least in part on interference; and
transmit a first reference signal associated with a channel for wireless communication.

26. The network node of claim 25, wherein the one or more processors are further configured to transmit a second reference signal associated with the channel, wherein a characteristic of the second reference signal comprises an indication for a user equipment (UE) to determine an interference measurement associated with the second reference signal and corresponding to a cause-oriented beam failure indicator.

27. A method of wireless communication performed by a user equipment (UE), comprising:
receiving, using a beam, a first reference signal associated with a channel for wireless communication; and
generating a cause-oriented beam failure indicator based at least in part on a determination of a beam failure cause associated with the beam.

28. The method of claim 27, further comprising receiving, using the beam, a second reference signal associated with the channel, wherein a characteristic of the second reference signal comprises an indication for the UE to determine an interference measurement associated with the second reference signal,
wherein generating the cause-oriented beam failure indicator comprises generating the cause-oriented beam failure indicator based at least in part on the second reference signal.

29. A method of wireless communication performed by a network node, comprising:
transmitting a cause-oriented beam failure indicator configuration that indicates a cause-oriented beam failure indicator, wherein the cause-oriented beam failure indicator comprises:
a first beam failure indicator that indicates a failure of a beam based at least in part on a channel quality of a channel, or
a second beam failure indicator that indicates a failure of the beam based at least in part on interference; and
transmitting a first reference signal associated with a channel for wireless communication.

30. The method of claim 29, further comprising transmitting a second reference signal associated with the channel, wherein a characteristic of the second reference signal comprises an indication for a user equipment (UE) to determine an interference measurement associated with the second reference signal and corresponding to a cause-oriented beam failure indicator.
